(19) United States
(12) Patent Application Publication
(10) Pub. No.: US 2013/0254139 A1
(43) Pub. Date: Sep. 26, 2013

(54) Systems and methods for building a universal intelligent assistant with learning capabilities

(71) Applicant: Xiaoguang Lei, Kitchener (CA)

(72) Inventor: Xiaoguang Lei, Kitchener (CA)

(21) Appl. No.: 13/845,541

(22) Filed: Mar. 18, 2013

Related U.S. Application Data
(60) Provisional application No. 61/685,554, filed on Mar. 21, 2012.
(60) Provisional application No. 61/849,194, filed on Jan. 23, 2013.

(51) Int. Cl. G06N 99/00

(52) U.S. Cl. CPC G06N 99/005
USPC 706/11; 706/12

(57) ABSTRACT

Systems and methods disclosed herein relates to building an intelligent assistant that can take in human requests/commands in simple text form, especially in natural language format, and perform tasks for users. Systems and methods are disclosed herein in which knowledge of how to interpret users' requests and carry out tasks, including how to find and manipulate information on the Internet, can be learned from users by the designed assistant, and the knowledge can be subsequently used by the assistant to perform tasks for users. Using the disclosed methods, the designed assistant enables a user to teach the assistant, by actually performing the task manually through the provided user interface, and/or by referring to some knowledge that the assistant already knows; the designed assistant may generate more generic knowledge based on what it learns, and can apply the more generic knowledge to serve requests that it has never seen and never directly learned, and can revise/improve the knowledge according to execution result/feedback. The methods and systems being disclosed here are useful for building an intelligent assistant, especially a universal personal assistant and an intelligent search assistant.

### RELATED APPLICATIONS

This application claims the benefit of U.S. Provisional Patent Application No. 61/685,554, filed Mar. 21, 2012, and entitled “Methods of building a universal intelligent assistant system”, and is hereby incorporated herein by reference. This application also claims the benefit of U.S. Provisional Patent Application No. 61/849,194, filed Jan. 23, 2013, and entitled “Methods of building a universal intelligent assistant system with learning capability”, and is hereby incorporated herein by reference.

### FIELD OF THE INVENTION

The present invention relates to computer systems and applications. More particularly, the present invention relates to intelligent assistant systems, especially intelligent personal assistant system.

### BACKGROUND OF THE INVENTION

Even though computer systems that assist human beings have been used extensively in modern society, intelligent computer assistant that can respond and serve according to ordinary human language input remained the subject of sci-fi novels and movies for decades, until recently. In recent years, intelligent personal assistant systems such as Siri running on Apple's iPhone brought the sci-fi stories into reality for ordinary people, and this kind of development emerged as a new domain of computer assistants. Instead of using traditional computer user interface such as windows, buttons etc. to interact with users, this kind of intelligent assistant can accept simple human natural language input (either as voice or text input) from a client device such as a smartphone, and do various tasks for the person using the device (see US20120016678 A1, US20120245944 A1, and EP2526511A2 by Apple Inc). This greatly simplifies the human-computer interactions. The intelligent user interface module of such assistant can take in human text/language input, then uses some language parser to analyze the input, and interacts with some internal function modules/sub-systems or external systems to perform tasks. For a non-limiting example, a user can communicate with Siri by speaking natural language through Siri's intelligent voice interface, and ask what the current weather is, what the nearest restaurants are, etc. The user can also ask Siri to launch other Apps installed in the user's smartphone. Other intelligent assistant examples include Google Now from Google Inc, which focuses on information search assistant functionality.

Despite of their usefulness, there is serious limitation as to what can be done by any of the current intelligent personal assistants described above. The way used to implement any current assistant is not very different from traditional software engineering, i.e. most of the intelligence and features provided by such assistant are the direct results of hard-coded engineering effort. As a result, the useful features/functionalities provided by any such assistant are destined to be limited. Typically, the features are restricted to a narrow scope of domains/categories, bounded by the native functionalities the assistant has been pre-engineered with, or the functionalities of the sub-systems or external systems with which the assistant has been designed to interact. It will take tremendous amount of work to implement or integrate with various functional systems, either internal or external. For a non-limiting example, currently Siri only integrates with a few external systems, such as WolframAlpha and Yelp, providing limited scope of services such as news, local business search, etc. provided by those integrated systems. Even though Siri can launch installed Apps, there is a limit as to how many Apps a human being can manage in a personal device. In addition, without engineering effort, assistant such as Siri cannot control the launched Apps' behaviors and cannot completely fulfill the users' intent. Consequently, the users still have to deal with each App's user interface even if they don't want to. Using traditional engineering effort, it is not possible to have some kind of “universal” assistant which can assist users to perform any task without limitations.

Another serious limitation is that truly customized or personalized service cannot be provided by any of the current assistants. Again, this is because, the functionalities of the above assistants are pre-engineered, and the sub-system or external system supporting any specific functionality is pre-determined depending on the domain/category of a user's command. The pre-engineered logic determines what native function to use, what sub-system or external system to dispatch the corresponding command to. For a non-limiting example, if a user asks Siri a math question, the question is mostly redirected to WolframAlpha for an answer, even though the user may know sources that can give better answers—unless the sources the user prefers has been integrated into the assistant, the assistant cannot use them. Additionally, with the current design of personal assistants, it is not possible to have an assistant specialized in one area, such as medical domain for a doctor, and another assistant specialized in another area such as arts for an artist. In order to accomplish these in traditional way, engineering effort has to be spent on developing and integrating those specialized systems.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram that shows various components of an intelligent assistant with learning capabilities.

FIG. 2 depicts an example of a flowchart of the high level process of serving a human request by a designed intelligent assistant.

FIG. 3 and FIG. 4 illustrate two alternative examples of system diagrams that show various components of an intelligent assistant with learning capabilities, with one using embedded application approach, while the other using external application approach.

FIG. 5 is similar to FIG. 2, but it depicts another (more sophisticated/detailed) example of a flowchart of the high level process of serving a human request by a designed intelligent assistant.

FIG. 6 illustrates a kind of configuration and deployment arrangement of some embodiments in which the designed assistant is a piece of standalone client software.

FIG. 7 illustrates a kind of configuration and deployment arrangement of some embodiments in which the designed assistant is an online service system that comprises both client software and an online back-end server system.

FIG. 8 illustrates the case in which client software designed using the disclosed invention may have some embedded utility/application software.

FIG. 9 illustrates the case in which client software designed using the disclosed invention may run in parallel with some external/standalone utility/application software within some client device, and communicate with the external/standalone utility/application software.

FIG. 10 illustrates that an online back-end server system designed using the disclosed invention uses storage sub-systems to save and maintain different types of knowledge databases, including shared public knowledge database and segregated private knowledge database.

FIG. 11 illustrates the case in which the designed assistant makes use of utility software and proxy for the observer and imitator functionalities, while the proxy is embedded/implemented within the client software, and the utility software can be standalone.

FIG. 12 illustrates the case in which the designed assistant makes use of utility software and proxy for the observer and imitator functionalities, while the proxy is implemented within the back-end server system.

FIG. 13 illustrates the flowchart of the user action observing process, for an embodiment in which the client software is a Google Android application running in a mobile device.

FIG. 14 illustrates the flowchart of the user action repeating/imitating process for an embodiment in which the client software is a Google Android application running in a mobile device

FIG. 15 illustrates the flowchart of the knowledge abstraction process in some embodiments.

FIG. 16 illustrates the flowchart of the process of doing pattern match and solution pattern instantiation in some embodiments.

FIG. 17 and FIG. 18 illustrate the system interactions and workflow steps of an embodiment in which the designed system is a piece of standalone client software.

FIG. 19 and FIG. 20 illustrate the system interactions and workflow steps of an embodiment in which the designed system has both client software and an online back-end server system.

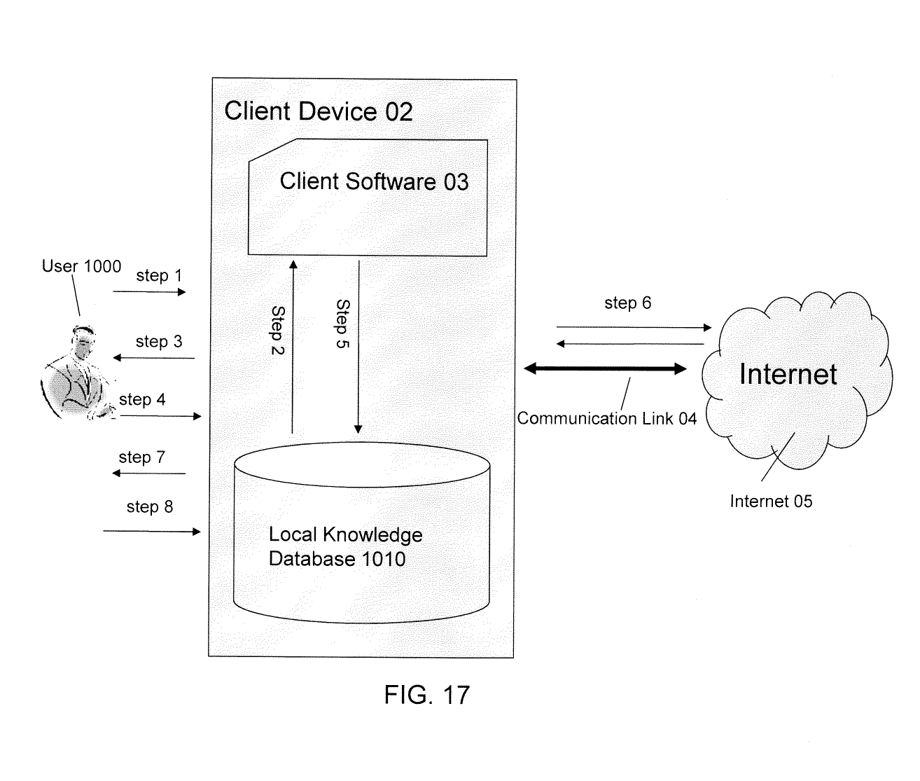

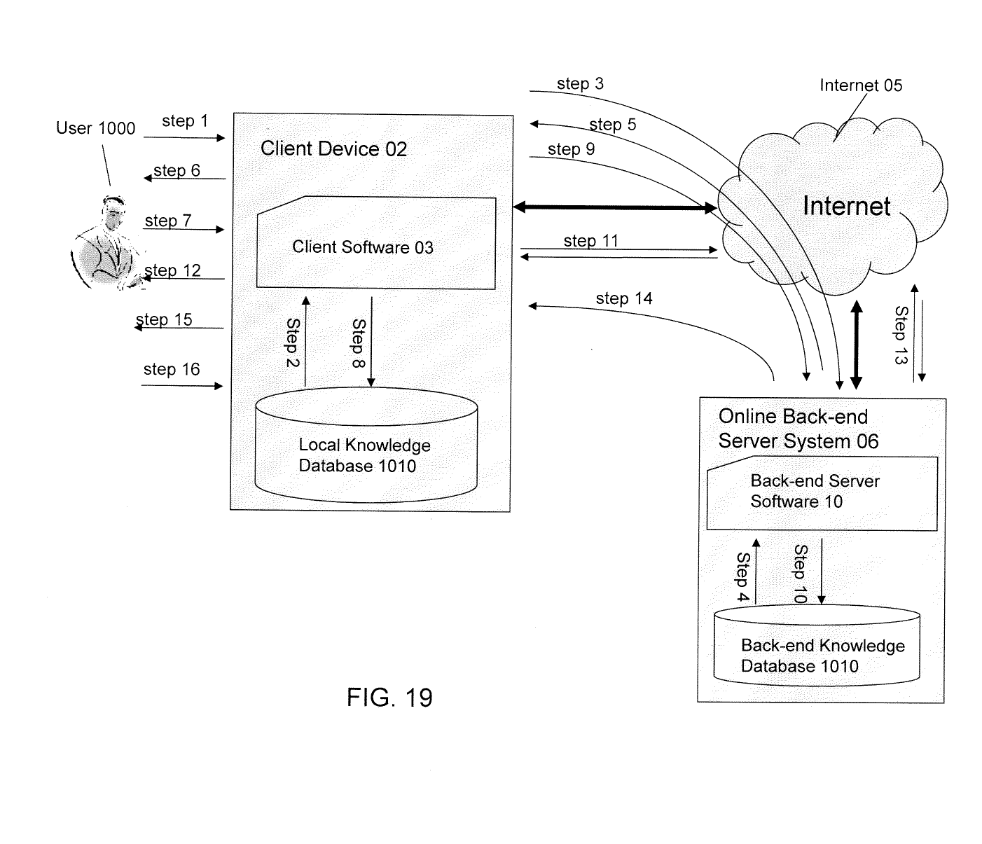

FIG. 17 and FIG. 19 highlight the aspects of how the designed system obtains some knowledge from a user for performing a task.

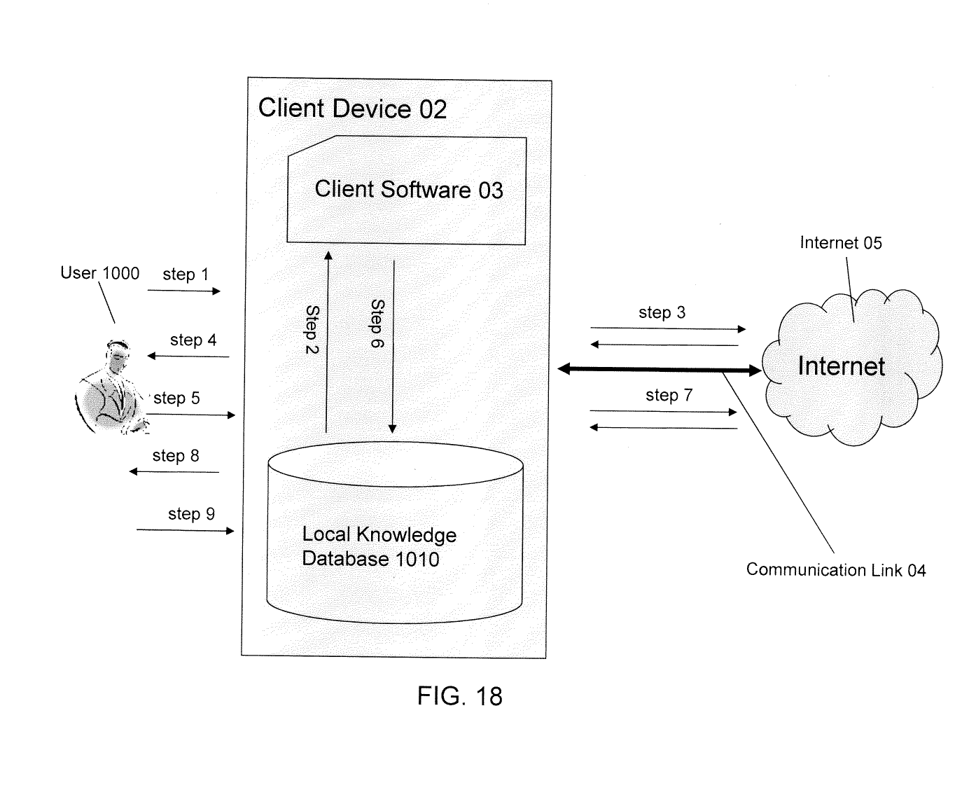

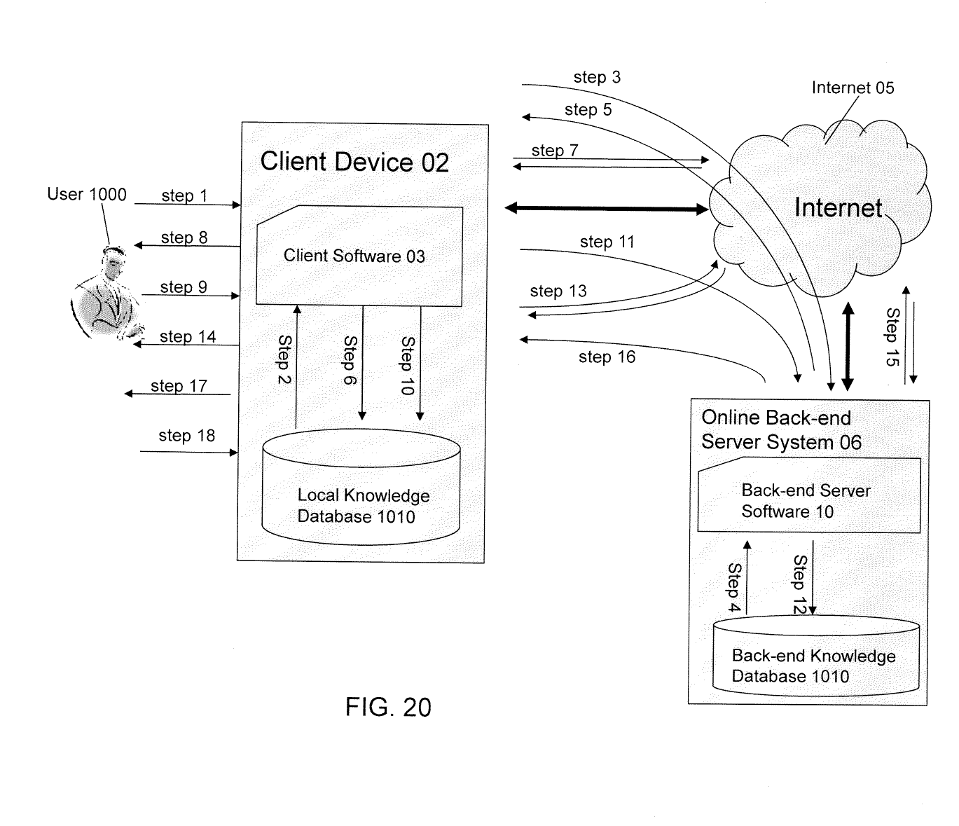

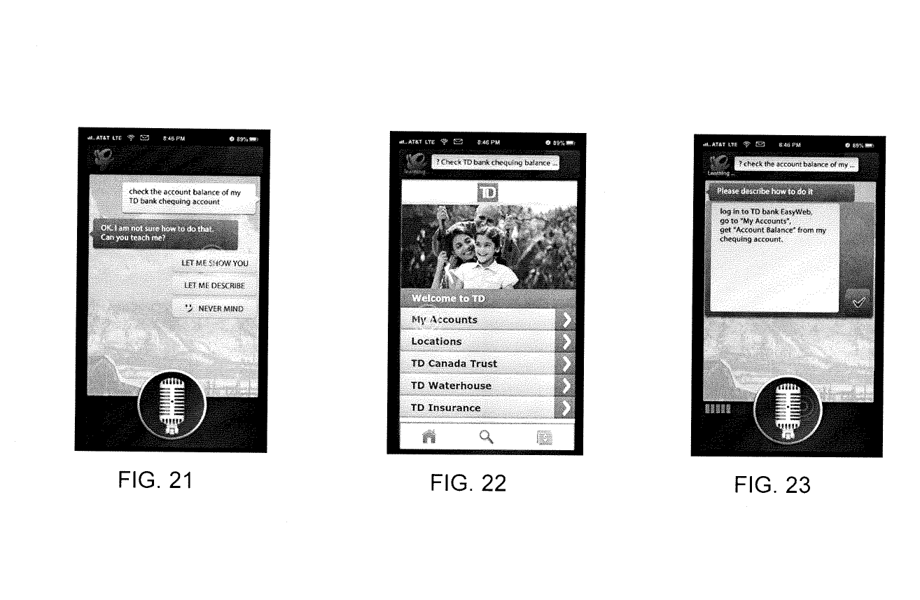

FIG. 18 and FIG. 20 highlight the aspects of how the designed system uses existing knowledge to perform a task for a user, and how the designed system enables revision and improvement of existing knowledge through more learning process.

FIG. 21, FIG. 22 and FIG. 23 illustrate some screenshots of examples of assistant-user interactions while learning how to serve a request from the user.

### DETAILED DESCRIPTION OF THE PREFERRED EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to build an intelligent assistant with learning capabilities that can take in human requests/commands in simple text form, especially in natural language format, and perform tasks for users. Under the proposed approach, the intelligent assistant acquires/learns the knowledge of how to interpret a user's requests and how to carry out tasks from the user, and subsequently uses the knowledge to perform tasks asked by the user. During the learning process, the intelligent assistant enables the user to teach the assistant by showing the assistant what and how by actually performing a task manually through the provided user interface, and/or by referring to some knowledge that the assistant already knows. The intelligent assistant may also generate more generic knowledge by itself based on what it learns, and can apply the more generic knowledge to serve requests that it has never seen and never directly learned before, and can revise/improve the knowledge according to execution result/feedback.

Under the proposed approach, the intelligent assistant is both truly versatile/universal and fully personalized/customizable because of the learning capabilities of the intelligent assistant. In fact, the functions and the behavior of the assistant are neither predefined/pre-engineered nor fixed; instead, they can be obtained and accumulated by learning from users. If implemented on a software platform, such intelligent assistant can utilize any applications available on/via that software platform to serve the user's requests. In addition, the intelligent assistant can do things only specific to the individual user who uses the assistant. The functionality and intelligence of such assistant can grow incrementally and recursively without any limitation on the categories of the user's requests it can serve.

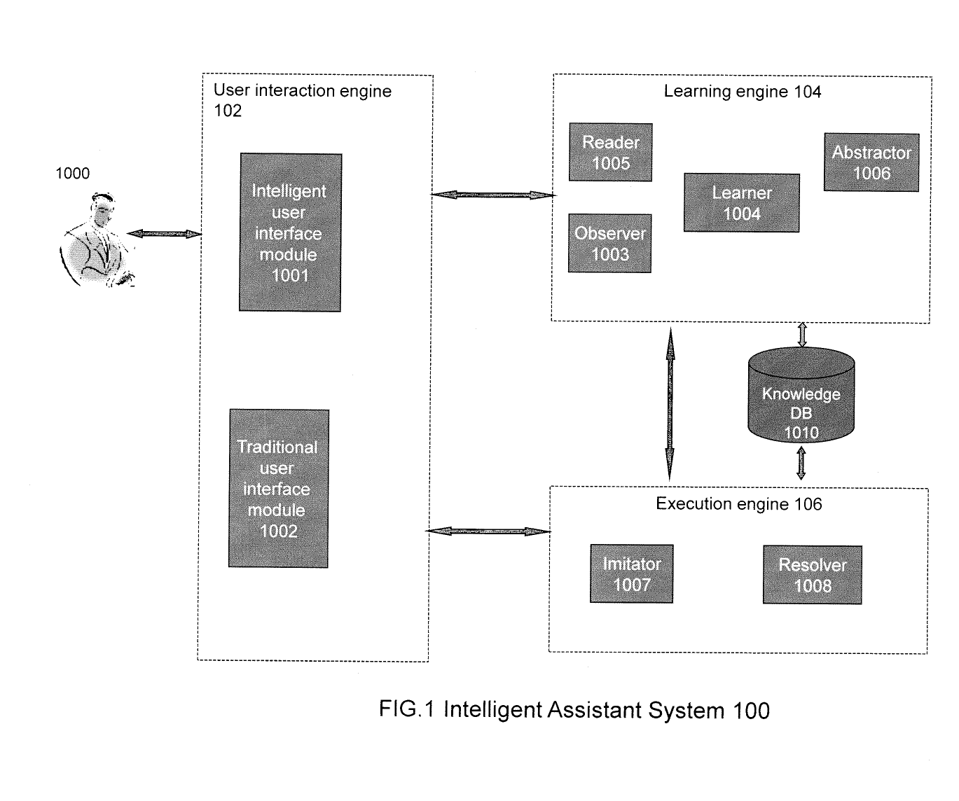

FIG. 1 depicts an example of a system diagram that shows various components of an intelligent assistant system 100 with learning capabilities. In this document, although the diagrams depict components as functionally separate, such depiction is merely for illustrative purposes. It will be apparent to one skilled in the art that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks. In addition, not all components/modules are necessary—some may be omitted in some embodiments.

In modern computing age, most computer application software is running on some sort of software platforms. One obvious kind of software platform is computer operating system, such as Windows, Linux, Android, etc. All kinds of client software can be developed on top of an operating system platform. Some client software is so popular, that it becomes a sort of general purpose standard/utility software that many specific-purpose applications can be running on, and/or be launched from. This kind of client software becomes a platform itself. The most popular case of this kind is web browser. All web application software is built around, and/or run within, a web browser platform. Platforms provide foundation and framework for application software, especially client software that contains user interface software, which can be developed using the libraries and development kits provided by the platforms. Popular platforms like Windows or web browser can have millions of different kinds of applications running on top of them. Although the disclosed invention herein can be used for any arbitrary application software and systems, the preferred embodiments of the invention are to implement them for platforms, so that the intelligent assistants can be “universal” for platforms, i.e. they can provide intelligent assistance for all applications running on top of the platforms. One embodiment of the invention is to implement the disclosed methods/systems for web browser platform, so that a universal intelligent assistant can support all kinds of web applications. Other embodiments of the invention may be applied to Android platform, Windows platform, etc.

Referring to FIG. 1, system 100 can be a brand-new intelligent web browser, supporting all web applications for web platform. The web browser can be an application system comprising some or all of the components illustrated in FIG. 1.

In the example of FIG. 1, the system 100 includes at least user interaction engine 102, learning engine 104, and execution engine 106. As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

In the example of FIG. 1, each of the engines can run on one or more hosting devices (hosts). Here, a host can be a computing device, a communication device, a storage device, or any electronic device capable of running a software component. For non-limiting examples, a computing device can be but is not limited to a laptop PC, a desktop PC, a tablet PC, an iPod, an iPhone, an iPad, a Google's Android device, a PDA, or a server machine. A storage device can be but is not limited to a hard disk drive, a flash memory drive, or any portable storage device. A communication device can be but is not limited to a mobile phone.

In the example of FIG. 1, each of the engines may have a communication interface (not shown), which is a software component that enables the engines to communicate with each other following certain communication protocols (such as software API calling conventions, TCP/IP protocol, etc.), over one or more communication channels or networks (not shown). Here, the communication channels or networks can be but are not limited to, internal software APIs, memory and bus within a computer system, internet, intranet, wide area network (WAN), local area network (LAN), wireless network, Bluetooth, WiFi, and mobile communication network. The physical connections of the channels and networks and the communication protocols are well known to those of skill in the art.

In the example of FIG. 1, user interaction engine 102 interacts with the user, accepting a user's requests for an operation via a computing device, providing answers/results to the user, and providing the user interface for learning. As used herein, user interaction engine 102 can be a part of a piece of client software running on some client device (especially personal computing device), such as some software running on a personal computer or smart phone. In the example of FIG. 1, user interaction engine 102 also provides user interface to interact with the user and enable the user to teach new knowledge in various means.

In some embodiments, user interaction engine 102 may include an intelligent user interface module 1001 to support intelligent, simplified communication with the user via human language input. The intelligent user interface module 1001 enables the user to present the requests in human language or gesture on what the user wants to perform via the computing device. User can give the task request in simple text form (or forms that can be translated into simple text form), wherein the task request may contain a simple description of the operation to be performed via the computing device. Note that the user may directly gesture to teach on how to serve a request, and in that case, the user request may also be an explicit teaching request/gesture on how to serve a request via the computing device. In some embodiments, the intelligent user interface module 1001 can accept the user's request in any simple non-text gesture (such as voice input) or encoded form that can be compared with each other, or can be translated into simple text form. The term “simple” used hereinafter means that an ordinary person without any technology skill can create such requests to the system without any difficulty, and natural language is obviously simple for an ordinary person to use.

In some embodiments, user interaction engine 102 may include a traditional user interface module 1002. From a user's perspective, the traditional user interface module 1002 is not different from any main stream computer interface, e.g. it may be a graphical user interface with windows, menus, forms, clickable icons, etc. The user may use this traditional interface 1002 to perform a task just as he would use any main stream application software interface. Module 1002 provides a user the traditional way of interacting with a computer or a computerized system, and it supports learning engine discussed below. The standard software with a traditional user interface a user normally uses to perform a task manually is sometimes referred to as “utility software” in this document, and one such non-limiting example is a traditional web browser—in that case, module 1002 is a traditional web browser interface. Note that the assistant can support more than one kind of utility software, and in such cases, it may have more than one kind of traditional user interface modules.

In the example of FIG. 1, learning engine 104 learns how to serve/execute user's requests via various means. The learning process includes but is not limited to obtaining or acquiring the knowledge (including steps, instructions, context, etc.) necessary for the underlying operating system or platform of the computing device to execute the request submitted by a user. As referred to hereinafter, a method or a set of instructions of how to carry out the task to satisfy a user's request is called a “solution” for the user's request. A reusable answer is also regarded as part of a solution. The solution, combined with the user's request and other related information, is called an instance of “knowledge” for the assistant.

In some embodiments, learning engine 104 supports “learning by observing”, which obtains or acquires knowledge by observing and recording what the user does to perform the operation step by step. In the learning by observing process, the learning engine 104 enables the user to show how to serve/execute a request by actually perform the operation step by step via the provided user interaction engine 102. In that case, learning engine 104 may further include an observer module 1003, which typically works with the user interaction engine 102 in the learning process. As mentioned the user may use the traditional user interface module 1002 of user interaction engine 102 to perform the task manually in traditional way. Behind the scene, observer module 1003 observes the user's interactions and collects related information together with the recorded user interactions, which may include additional information provided by the user. The information being observed and collected may include all the steps of actions (and consequences of those actions) to perform the task, and the related information such as context of the actions. In the case that the system 100 support multiple kinds of utility/application software, the information being observed and collected includes which utility/application software the user chooses to use in order to execute the task.

In some embodiments, observer module 1003 may utilize a traditional web browser interface (1002) for the above learning by observing process, so that the user can use the user interface to show the learning engine 104 how to perform the task manually using a web browser. The traditional web browser interface (1002) enables a user to browse and navigate the web, to perform any task with any web site that enables the user to do things with, just like the way a user normally does with a normal web browser. During the process, the observer module 1003 captures/records the user's browsing and navigating behavior. The observer module 1003 may also provide opportunities for the user to provide additional information about the user's navigation and actions in order to accomplish the task, which for non-limiting examples, may include what data and status to use and/or collect, or under what condition user performs certain actions, etc. Note that the user may not need to complete the task from start to finish if enough information/knowledge has been collected on how to perform the operation, although it may happen. The observer module 1003 stops capturing/recording when the user finishes teaching the observer module 1003. The user may signal the end of learning process through intelligent user interface module 1001. Note that for privacy concerns, observer module 1003 may only observe and remember/record user's behavior under user's permission.

In some embodiments, the learning engine 104 can learn by observing the user how to search for information related to performing the operation requested on the Internet (or intranet) using a browser interface. Differing from a traditional search instead of just giving out links/references or content that may contain, or lead to, real/direct answers, the intelligent assistant can deliver real/direct answers to users based on real-time data from a real-time search, or based on using a traditional web search engine system. With the learning by observing process, the learning engine 104 may enable the user to navigate to the web page(s) that contain(s) the interested information, and enable the user to tell which part of the web page contains the interested information, optionally by highlighting or clicking the corresponding part of the web page. The observer module 1003 can observe and remember user's search actions, along with the content, type, location and other context of the interested information, so that this searched information on the web can be located again easily later on. Combined with semantic analysis and/or other learning methods, better result may be obtained, and the learning process may be simplified, e.g., the learning engine 104 may only need to know which web site may contain the information the user is interested in, then the assistant can figure out how to locate the information for the user.

In some embodiments, the knowledge obtained from the above learning/searching processes can be automatically verified by learner module 1004 (as discussed below) of learning engine 104. The learner module 1004 can verify a search solution through execution engine 106 discussed below by conducting a search task not associated with any real user request. The learner module 1004 can verify a search solution periodically to ensure its validity, even if the solution has been used successfully before.

In some embodiments, learning engine 104 further includes a learner module 1004 that is responsible for generating knowledge necessary to perform the operation requested by the user. In some embodiments, learner module 1004 is also responsible for directing other learning modules (such as observer module) in the learning engine 104 and controlling the overall learning process. When a user shows the learning engine 104 how to serve a request as mentioned above, the observed information is sent by the observer module 1003 to the learner module 1004 to process and record. By digesting the observed information, along with the request related information, learner module 1004 is able to generate new knowledge about how to serve the user request. Learner module 1004 makes sure that the knowledge is generated in the proper form that can be used later by the system 100 to serve future user request. The new knowledge is saved into knowledge database (DB) 1010 as discussed below. If the same request is received later, the task can be performed without going through the above learning process again. Learner module 1004 is also responsible for verifying/refining the knowledge before and/or after it is saved into knowledge database. Learner module 1004 may use abstractor module 1006 discussed below to figure out the intention of observed user's actions in order to generalize the knowledge (as also discussed below).

In some embodiments, learning engine 104 enables a user to teach the system 100 new knowledge by describing in simple text or via non-text gestures (e.g., voice) on how to interpret and serve a user's request, using existing knowledge that the system 100 already possesses in the knowledge database 1010, i.e. the learning engine 104 is able to “learn by reading”. In that case, learning engine 104 may further include a reader module 1005, which reads user's teaching input from user interaction engine 102. Here, the reader module 1005 enables user to describe how a task can be performed, possibly by splitting it into parts/steps that the system 100 knows how to execute using existing knowledge. The existing knowledge can be referred to using human natural language in the description. The reader module 1005 can parse user description using existing knowledge. This means that reader module 1005 can look up knowledge database 1010 for existing knowledge. The parsed user description can be delivered to learner module 1004, and the latter can digest and form new knowledge, verify/refine the knowledge, and save it into knowledge database 1010. In some embodiments, the existing knowledge may have been pre-engineered, or may have been obtained by learning (e.g. from user as mentioned). In the latter case, learning engine 104 can build new knowledge recursively.

In some embodiments, in the process of “learning by reading”, user interaction engine 102 may provide typing or voice input and editing functionalities. The reader module 1005 in learning engine 104 may cooperate with user interaction engine 102 to provide hints about existing knowledge of the assistant, before, during and/or after user's request input. In case a user's request task can be split into a plurality of parts as sub-tasks or steps, optionally, reader module 1005 may ask user interaction engine 102 to present a task editor interface (not shown) to facilitate the process. Reader module 1005 may interact with the user through the task editor interface, enabling the user to enumerate, describe, and organize sub-tasks/steps in simple human language, and to add conditions and constraints to sub-tasks/steps easily. The reader module 1005 can parse and interpret the sub-task description, and it may verify each sub-task to make sure that the sub-task can really be interpreted and executable using existing knowledge of the assistant. The reader module 1005 may also parse and interpret the organization and/or order of the sub-task list, including whether some sub-task has to be repeatedly executed. As an example of “learning by reading”, supposed the assistant already knows how to calculate the area of a circle (this knowledge may have been learned from a user previously), a user can teach the assistant how to calculate the volume of a cylinder, by describing the solution as “first, calculate the area of the base circle of the cylinder, then, multiply the result with the height of the cylinder”. The reader module 1005 will send the parsed user description to learner module 1004, and the latter will generate corresponding knowledge for future execution purpose, verify and save the knowledge into knowledge database 1010. If the same request is received later, the task can be performed without going through the above learning process Note that this capability of “learning by reading” does not necessarily limit the source of reading to users, although the focus here is from users.

In some embodiments, the learning engine 104 can utilize both “learning by observing” and “learning by reading” in order to fully understand how to handle a user's request. For example, in the above learning by reading process, if the learning engine 104 does not know how to interpret or handle a sub-task description, it may ask the user to show how to do the sub-task manually, i.e., turn the user interface into the aforementioned learning by observing process.

Learning engine 104 can use both “learning by observing” and “learning by reading” to learn directly from a user in real time to acquire new knowledge. learning engine 104 may acquire new knowledge (as an indirect way of learning), not directly from user or any external sources, but through “knowledge abstraction” as discussed below.

In some embodiments, learning engine 104 forms/generates new generic knowledge on how to perform the operations requested by the user from existing knowledge (including examples learned in the process described above), wherein the new generic knowledge is saved into knowledge database 1010. The process of getting more generic knowledge is referred to hereinafter as “knowledge abstraction”. In some embodiments, learning engine 104 further includes an abstractor module 1006 to do knowledge abstraction. Given any learned example and/or new input, abstractor module 1006 may further process existing knowledge to potentially gain more generic knowledge. Abstractor module 1006 takes existing user request(s) and corresponding solution(s) as input, and tries to figure out potential request and solution “pattern”, and may generate a generic form of request (pattern) and a generic form of task execution solution (pattern). The generic form of request and solution being obtained through knowledge abstraction can be subsequently used by execution engine 106 discussed below to serve different requests from users, which enables the system to serve a user request that the system has never seen and has never learned directly from a user before, thus, the capability of the learning engine 104 is not limited to what it literally learns, either from observing or from reading.

The aforementioned knowledge abstraction process is an induction process, in which instance(s) of concrete knowledge and/or less generic knowledge can be used to construct more generic knowledge. In the invention, an instance of concrete knowledge may comprise a user request and solution(s) to serve the corresponding request. Based on the observed instance(s), abstractor module 1006 can generate user request pattern(s) and solution pattern(s) using various reasoning models and techniques. The generated request patterns and solution patterns can be further processed (recursively) to generate even more generic patterns. As a non-limiting example, one simple reasoning model that can be used is to find correlations and commonalities among user requests, and to find correlations between a user request and its corresponding solution(s). For example, given the solutions to user's question of “what is the temperature of New York now?” and “what is the temperature of Boston now?”, abstractor module 1006 can notice that the two corresponding solutions may only be different in terms of the city name being used; and it would notice that the city name appearing in the user request also appears in the corresponding solution; thus, abstractor module 1006 may generate a request pattern such as “what is the temperature of * now?”, in which “*” can be replaced by some city name; and similar operation can be done to the solutions in order to generate solution patterns. By knowledge abstraction, abstractor module 1006 can generalize the process of how to get the current temperature of any city, such as that of Chicago and Los Angeles, even though the assistant never directly learns how to do that from the user before. In the field of artificial intelligence study, there may be other algorithms and models that can be used for the knowledge abstraction process, including probability models, semantic analysis etc. Note that the “*” being used here is just for illustration, and it does not necessarily mean that abstractor module 1006 has to use exactly the same format. Knowledge abstraction process can happen when new knowledge is obtained from a user, and it can also happen at any time when new information is available. The new information mentioned here can be from users, and it can be from the process of performing tasks and accessing the Internet. In the learning by observing process, abstractor module 1006 may be used to figure out the intention of user's actions, possibly by trying to use meaningful context and correlations among request and action steps, so that generic form of actions serving as generic solutions can be generated. Same applies to the learning by reading process.

In some embodiments, learning engine 104 is able to improve, revise its knowledge based on execution history of user requests including results and feedbacks, which are usually collected and saved in knowledge database 1010 as part of the learned knowledge as well. The result/feedback are normally collected and saved by execution engine 106 discussed below. In some embodiments, knowledge database 1010 also saves and maintains learning history. In some embodiments, learner module 1004 may use the above saved data to verify, revise and improve the assistant's knowledge. For a non-limiting example, if some existing knowledge is applied to some user request, and successfully serves the user, the learner module 1004 can reinforce the knowledge by incrementing the credibility weighting of the knowledge. If some knowledge is applied but results in not fulfilling user's request, the credibility weighting of the knowledge may be decremented, or the knowledge may even be invalidated and removed by learner module 1004. It is possible that learner module 1004 may even actively engage with execution engine 106 to obtain and/or verify new knowledge. “Learning from execution feedback” can be used for improving existing knowledge, while it has the potential to acquire new knowledge as well. “Learning from execution feedback” is especially important for correcting/improving the knowledge generated by “knowledge abstraction”.

In the example of FIG. 1, execution engine 106 serves/executes the user's requests using existing knowledge known to the system 100, e.g., maintained in knowledge database 1010. In some embodiments, execution engine 106 may include a resolver module 1008 that is responsible for finding solutions and serving/executing user's requests. When a user request is accepted by intelligent user interface module 1001, it is delivered to resolver module 1008 for analysis, interpretation, and searching for potential answers and solutions to fulfill the user request. Resolver module 1008 may look up the knowledge database 1010 in order to provide answer(s) to a user's request, and/or to retrieve instruction(s) to perform the task in order to serve the user's request. If the user request has been learned and corresponding knowledge has been saved before, resolver module 1008 is able to get it directly from the knowledge database without executing any instructions on the computing device. If some answer is found, it can be given back to the user. If there is some task that has to be executed and the method of how to execute is found, resolver module 1008 will perform the task for the user, possibly by engaging with some other internal modules (such as imitator module 1007 discussed below) and/or some external systems. Resolver module 1008 may also use a plurality of existing solutions/answers to serve the user's request, if it finds the request to be equivalent to a combination of a plurality of other requests for which solutions/answers can be found in the knowledge database 1010.

In some embodiments, execution engine 106 may include an imitator module 1007 that enables repeating/imitating what the user performed on/via the computing device according to user actions observed and recorded in the “learning by observing” process. Imitator module 1007 can interact with the underlying operation system or platform of the hosting device to perform the task on the user's behalf, just as the user would interact with the underlying platform directly to perform the task. In some embodiments, the imitator module 1007 may drive the traditional user interface module 1002 to do the corresponding task, just as if it were driven directly by user, and module 1002 in turn drives some function module(s) or system(s) (not shown) to actually execute the task function. In some embodiments, the process can be optimized so that the imitator may directly drive the function module(s) or system(s) to accomplish the task function. With respect to the “learning by observing” process, imitator module 1007 can provide the supporting functionality, i.e. it makes sure that the information observed by the learning engine 104 can be used to construct executable solution. For example, using the imitator functionality, the assistant can repeat/imitate the user's actions (e.g. clicking, typing in a user interface, browsing/navigating with a browser), and to finish the task as if it were performed by the user. Note that imitator module 1007 does not need to completely mimic what the user does, as long as it can perform the task that satisfies the user's request.

In some embodiments, if a request has not been directly learned, but matches some generic request pattern generated by knowledge abstraction, the resolver module 1008 can also retrieve the corresponding solution(s) for the request—in that case, a pattern match occurs, and solution pattern(s) found in the knowledge database 1010 can then be used by resolver module 1008 to create concrete solution(s) for the new request, and the created solution(s) may be used to perform the task in order to satisfy user's new request. The process of creating concrete solutions (or solution instances) from solution patterns is referred to herein as “instantiation” of the solution patterns. The process of doing pattern match and instantiation is a deduction process in which generic knowledge is used to match and serve concrete user requests.

In some embodiments, execution engine 106 can save the execution state and history like result and feedback into knowledge database 1010. The feedback can be from internal execution, and can be from users. In some embodiments, execution engine 106 delivers the result/status of the task execution to the user at any time convenient for the user. At that time, execution engine 106 may give the user the option to verify the correctness of the execution, or dismiss the result as incorrect/incomplete if undesirable. The saved result and feedback can be used by the learning engine 104 to revise/improve existing knowledge as mentioned before.

In the example of FIG. 1, the knowledge database 1010 maintains a set of knowledge of how to serve user requests, wherein such knowledge comprises a mapping between potential user requests, and answers/solutions to fulfill the user requests, including methods/instructions of performing corresponding tasks to serve the user requests. As used hereinafter, the term “mapping” doesn't imply any specific data structure or implementation. It just means that given some saved potential user request, it is possible to find the answers/solutions of performing corresponding task to serve the request, and vice versa. The mapping between potential requests and solutions may be direct or indirect. For a non-limiting example, in some design, there may be a first mapping from request input to interpreted user intent, and a second mapping from intent to solution. Note that the request being stored in the knowledge database may include some implicit context information besides the user's explicit input. In some embodiments, learner module 1004 may try to find any possible implicit/hidden information associated with a user's request, and attaches the implicit/hidden information to the request in the knowledge database. The solutions are saved in the format that can be used by the execution engine 106 to perform corresponding tasks with the underlying operation system or platform of the hosting device, i.e., they constitute executable solutions for user's requests. In some embodiments, the knowledge database 1010 also maintains a mapping between request patterns and solution patterns. In some embodiments, the aforementioned mapping is implemented using relational database tables, in which each request and solution pair may be stored as a knowledge instance row with request and solution occupying different columns.

In some embodiments, the system 100 can be used by a plurality of users, and the knowledge learned from individual users can be classified into private knowledge and public/sharable knowledge. Knowledge database 1010 can properly segregate the learned knowledge, and manage the accessibility of the knowledge accordingly, so that different private knowledge can only be accessible for its intended user or user group(s).

In some embodiments, knowledge database 1010 may be pre-populated with a set of common knowledge to be used to perform the operation requested by the user without learning first. In some embodiments, the common knowledge may be obtained from a special kind of users—tutors and trainers of the assistant system. The responsibility of tutors and trainers mentioned here is to convey the knowledge of human beings to the assistant. It is sometimes preferable that an assistant system 100 be “trained” by tutors and trainers before being delivered for end user usage. This process is similar to training human assistants before letting them to work for customers.

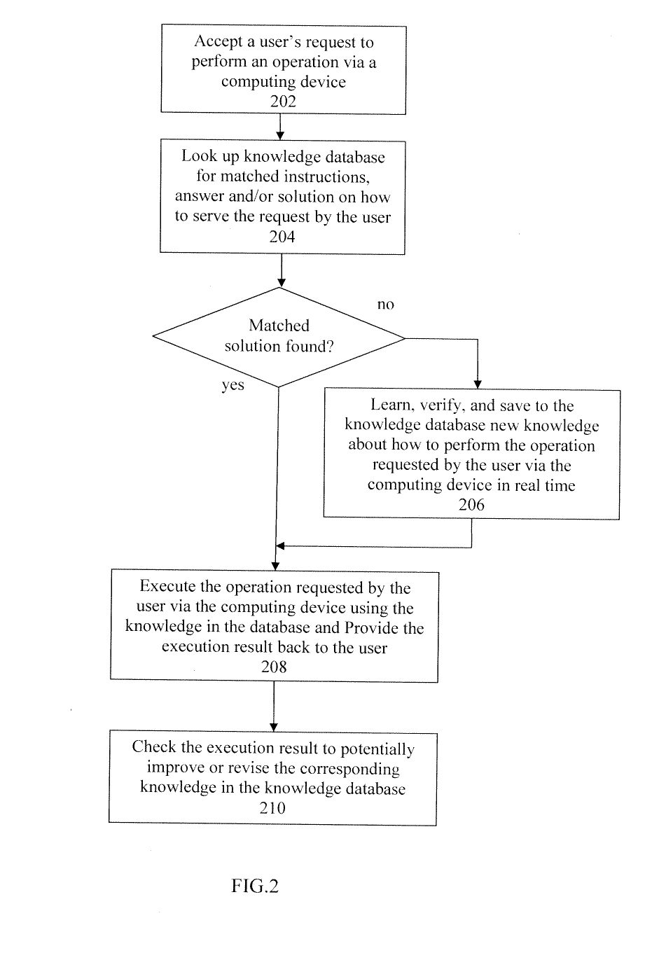

FIG. 2 depicts an example of a flowchart of the high level process of serving a human request by a designed intelligent assistant. Although this figure depicts functional steps in a particular order for purposes of illustration, the process is not limited to any particular order or arrangement of steps. One skilled in the relevant art will appreciate that the various steps portrayed in this figure or any other figures could be omitted, rearranged, combined and/or adapted in various ways.

In the example of FIG. 2, the flowchart 200 starts at step 202 where a user's request to perform an operation via a computing device is accepted. The flowchart 200 continues to step 204 where matched instructions, answer and/or solution on how to serve the request by the user is looked up in a knowledge database. If no existing knowledge is found in the knowledge database on how to serve the user's request, or if the user wants to teach new knowledge on how to serve the user's request (the user may gesture to teach new knowledge regardless of whether there is existing knowledge to serve the request), the flowchart 200 continues to step 206 where new knowledge about how to perform the operation requested by the user via the computing device is learned, verified, and saved to the knowledge database in real time. The flowchart 200 continues to step 208 where the operation requested by the user is executed via the computing device using the knowledge in the database, and the execution result is provided back to the user. Note that if an answer is readily available from the knowledge database, it may just be provided back to user without further executing any instructions. The flowchart 200 optionally continues to and ends at step 210 where the execution result is checked to potentially improve or revise the corresponding knowledge in the knowledge database.

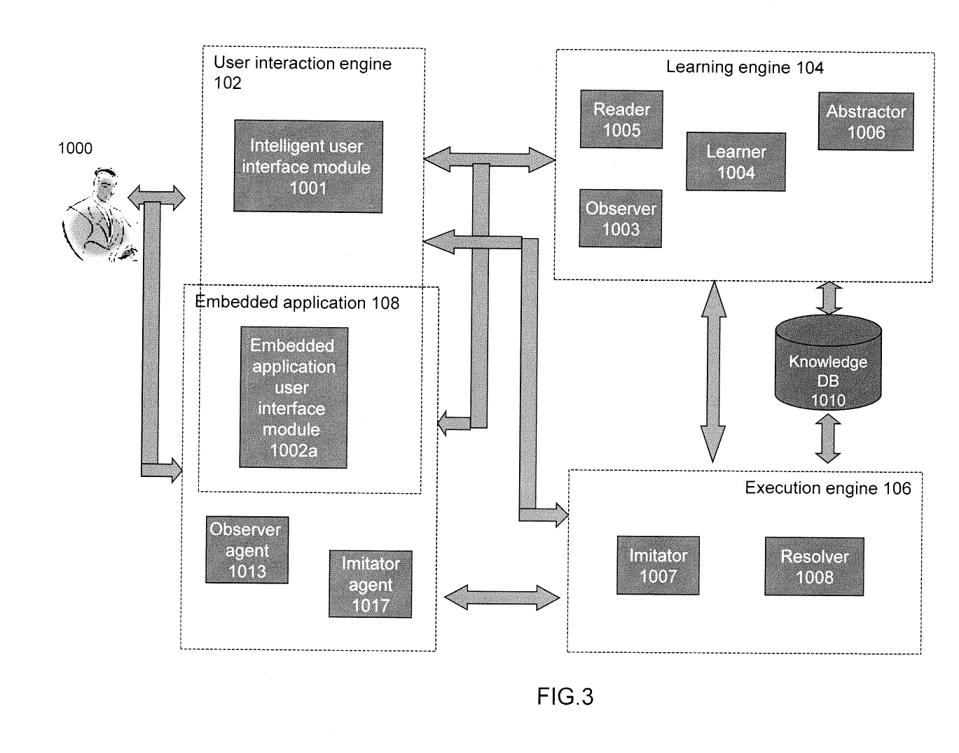

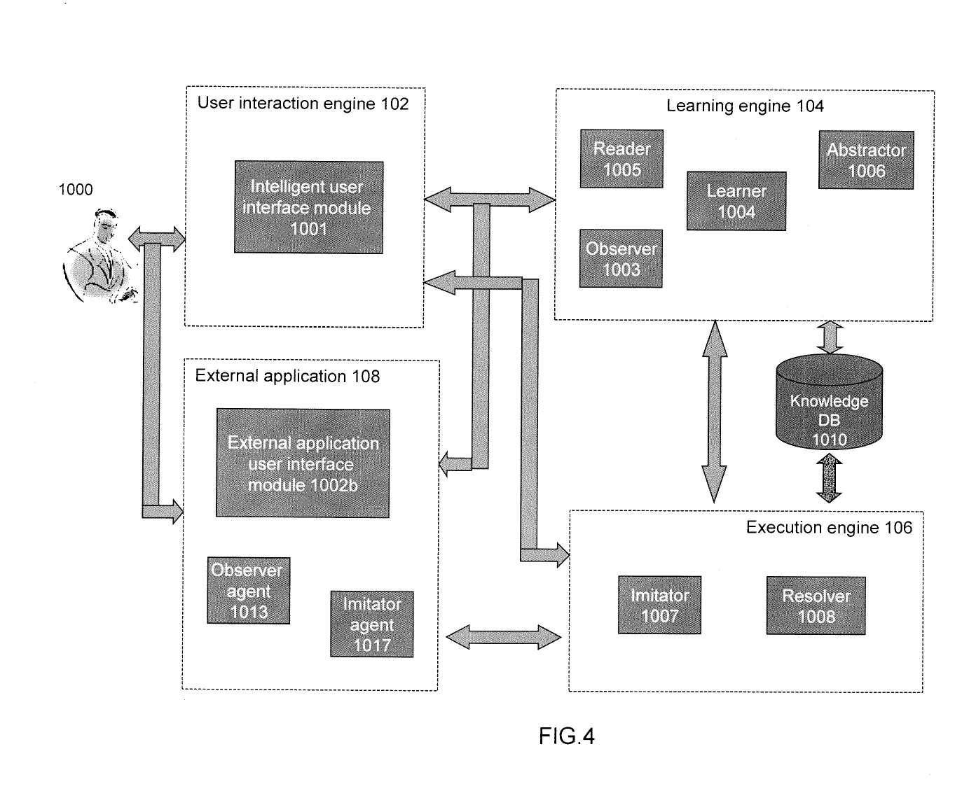

FIG. 3 and FIG. 4 illustrate two alternative examples of system diagrams that show various components of intelligent assistant system 100 with learning capabilities. Note that the majority of the components in each of the two cases are similar to, or the same as those of FIG. 1, but that should only demonstrate the applicability of the disclosed principles of the invention, and should not be regarded as restrictions and requirements. There can be additional components in some variations, and there can be certain components missing or omitted in some variations, and the ways the components are combined to form sub-systems/engines may be different. On the other hand, the main principles explained herein are applicable to all the variations of the embodiments.

In the example of FIG. 3, instead of designing and implementing all the features of intelligent assistant system 100, existing or third-party application software module(s) are incorporated into the system. In some embodiments, existing/third-party application software is embedded into the designed system as embedded application 108 in FIG. 3, either as dynamically linked module or statically linked library. Compared to FIG. 1, embedded application user interface module 1002a in FIG. 3 corresponds to the traditional user interface module 1002 in FIG. 1. Module 1002a is part of the embedded application 108, while being integrated into the user interaction engine 102. In some embodiments, the assistant system 100 is part of a software platform, and embedded application 108 is an application running within or on top of the software platform.

In the example of FIG. 4, the system 100 may be even more loosely coupled compared to that of FIG. 3. In FIG. 4, external application 108 can be a separately running application driven by (and maybe in parallel to) the intelligent assistant system 100. Application user interface module 1002b in FIG. 4 corresponds to 1002 in FIG. 1. In the example of FIG. 4, the system 100 can be an application itself that drives the external application, and both may be running on top of a software platform.

In the example of both FIG. 3 and FIG. 4, multiple applications may be supported. In some embodiments of system 100, user interface module 1001 of user interaction engine 102 enables user to select from multiple applications to run, and learning engine 104 (through observer module 1003 and learner module 1004) can remember user's selection as part of the “learning by observing” process, and incorporate it as part of the assistant's knowledge.

In some embodiments, at least part of the observer module/code of the learning engine 104 and/or imitator module/code of execution engine 106 can be made to run within existing/third-party applications. In the example of both FIG. 3 and FIG. 4, in some embodiments, there is an observer agent module 1013 that resides in the existing/third-party (embedded or external) application 108 while working on behalf of observer module 1003 of learning engine 104. The observer agent module 1013 contains at least part of the observer functionality mentioned before. Similarly, in some embodiments, there is an imitator agent module 1017 that resides in the existing application 108 while working on behalf of imitator module 1007 of execution engine 106. The design is to work around the fact that existing/third-party applications usually don't support the observer and imitator functionalities natively.

In some embodiments, the observer agent module 1013 of learning engine 104 and imitator agent 1017 of execution engine 106 can be loaded into, or linked with, the existing/third-party applications, either dynamically or statically. This is possible for a lot of modern applications, since modern applications often allow dynamic code loading and/or functional extensions by providing various extension APIs. For example, a modern web browser can load a lot of dynamic code to run either as extension of the browser functionality, or as part of a web application. More details will be provided in subsequent sections.

In some embodiments, observer agent module 1013 of learning engine 104 and imitator agent module 1017 of execution engine 106 are implemented using the properties of the event-driven programming model which is popular in modern computer user interface designs. In this kind of user interface programming model, users' actions can be captured by the system as some events, which can trigger certain software code to run. The technique used by the embodiments is to intercept the event in order to observe user's actions, and to replay the event in order to imitate user's actions.

In some embodiments, the observer agent module 1013 of learning engine 104 and imitator agent module 1017 of execution engine 106 are implemented within the platform application development kits/libraries, so that all applications developed using the development kits/libraries can have them. For example, applications running on top of Android operating system are normally developed using Android development tool kits and libraries. The user interface components such as menus, buttons, input boxes etc. are provided/supported by Android libraries and tool kits, and event-driven model is also used here. In some embodiments, Android development tool kits and libraries are designed to provide native support for user event interception and replay, so that the observer agent module 1013 and imitator agent module 1017 are available for all applications built using the development tool kits. As a common convention, development tool kits and libraries are usually backward compatible, thus, existing application source can just be recompiled to get the new functionalities, and no need to re-implement any existing application. Similar approach can be used in other system platforms such as Windows, so that all Windows applications can be assisted by intelligent assistant.

In some embodiments, the system 100 illustrated in FIG. 3 and FIG. 4 interact with Internet or external functional systems to perform tasks, and observer agent module 1013 of learning engine 104 is implemented using the so-called “proxy” mechanism. A “proxy” is an entity that acts as the gateway between utility software and Internet or external system, i.e., the utility software interacts with the said proxy to access Internet or external system. In some embodiments, observer agent module 1013 (or even observer module 1003 itself) of learning engine 104 is implemented in a proxy, or dynamically loaded by the proxy into the utility software in order to intercept and observe user's actions. Similarly, imitator agent module 1017 (or even imitator module 1007 itself) of execution engine 106 is sometimes implemented using the proxy mechanism to perform tasks. Details will be discussed later.

In the example of FIG. 4, in some embodiments, reader module 1005 of learning engine 104 may get more information from some external source (not shown) to learn more about external application related knowledge, such as how to launch and control external applications with different parameters, etc. The external source may or may not be part of the external application 108. The external source may contain a “request to launch-method/execute-method” mapping knowledge, so that learner module 1004 of learning engine 104 can learn through reader module 1005 by reading the publication for sophisticated ways of launching/executing the application, such as what parameters to use in the application launching API. This special mapping knowledge can also be incorporated into the assistant's knowledge as mentioned Upon receiving a new user request, the system 100 may use “learning by observing”, by showing the special mapping requests and associated info to the user for selection, and learn from user's selection, so that similar future request can be executed automatically. In some embodiments, the external source can be some mobile application download sites, and using the technique, the intelligent assistant can download, install and execute external applications on demand automatically. In this way, the capability of the intelligent assistant system 100 is not restricted to installed application only—it can use any application that is available on the Internet dynamically.

In some embodiments, the system 100 of FIG. 4 is an intelligent assistant running on an Android mobile device, and a standard is specified to publish mobile application's purpose and potential launch/execute methods in both the application's manifest file and application download sites. An example of application purpose and launch method description may look like “[Toronto bus schedule: get next bus arrival time for bus stop 11] [com.torontottc.schedulepackage, 11]”. The first part has a purpose summary “Toronto bus schedule” and an example request “get next bus arrival time for bus stop 11”, and the second part has a launch description containing the application package name and Intent parameters (in Android, “Intent” is used to launch and pass parameters to another application). The above example is for illustration purpose only, since the actual case can be more complicated—for example, the launch description may contain information about where/how to send back result to the assistant program if such result is available, etc. For installed applications, this kind of information can be stored within some “meta-data” portion of the application's manifest file readable by Android system and other applications. The reader module 1005 of learning engine 104 can read this information; and upon receiving a user request that may match the purpose and usage description, the assistant may show the example request information to user to assist launch selection—if selected, the application can be launched with appropriate parameters with the help from the abstractor module 1006 of learning engine 104, and the new mapping knowledge will be remembered in the assistant's knowledge database—i.e. a mix of “learning by reading” and “learning by observing” and knowledge abstraction. For application download sites, the aforementioned published information can be stored as meta-data file along with the application executable file, and is searchable and downloadable by any mobile application, including the aforementioned assistant program. The user interaction engine 102 can show this information to the user (maybe along with other public information available on the download site) when a user request can potentially be satisfied by running this application—if selected, the application will be dynamically downloaded, installed and executed with the permission of the user, and the learning engine 104 will remember this in its knowledge. In this way, application automatic download-on-demand, install-on-demand and execute-on-demand can be supported.

In some embodiments, the client software of system 100 is a web browser running in a personal computer. The embodiment uses browser extension mechanism to implement observer and imitator functionalities. In this embodiment, there is a back-end server system. The back-end server system is implemented as a web service site on the Internet. When a user uses a browser to access the web service site, a special plugin/extension can be loaded to the browser from the back-end server system. The special plugin/extension contains the observer agent module 1013 of learning engine 104 implemented by using browser standard event capturing functionality. The special plugin/extension may also contain the imitator agent module 1017 of execution engine 106 implemented by using browser standard event replaying functionality. When a user uses the said browser to access the web site of the back-end server system, the web user interface of the web site (acting as intelligent user interface module 1001 of user interaction engine 102) would accept user's requests in human language input and perform tasks for the user. The web site special user interface code may trigger a learning process by using the plugin/extension code, if the system doesn't know how to handle a new user request. A separate learning window may be popped up at the beginning of a learning process, acting as the container for external web application and the user can use this learning window to teach the system about task performing knowledge, by going to any web site, running any external web application and manually performing the task. In the meantime, the original window is used to control and guide the learning process. Once the user signals the end of the learning process using the control window, the separate learning window would disappear, and the system can do tasks using the learned knowledge.

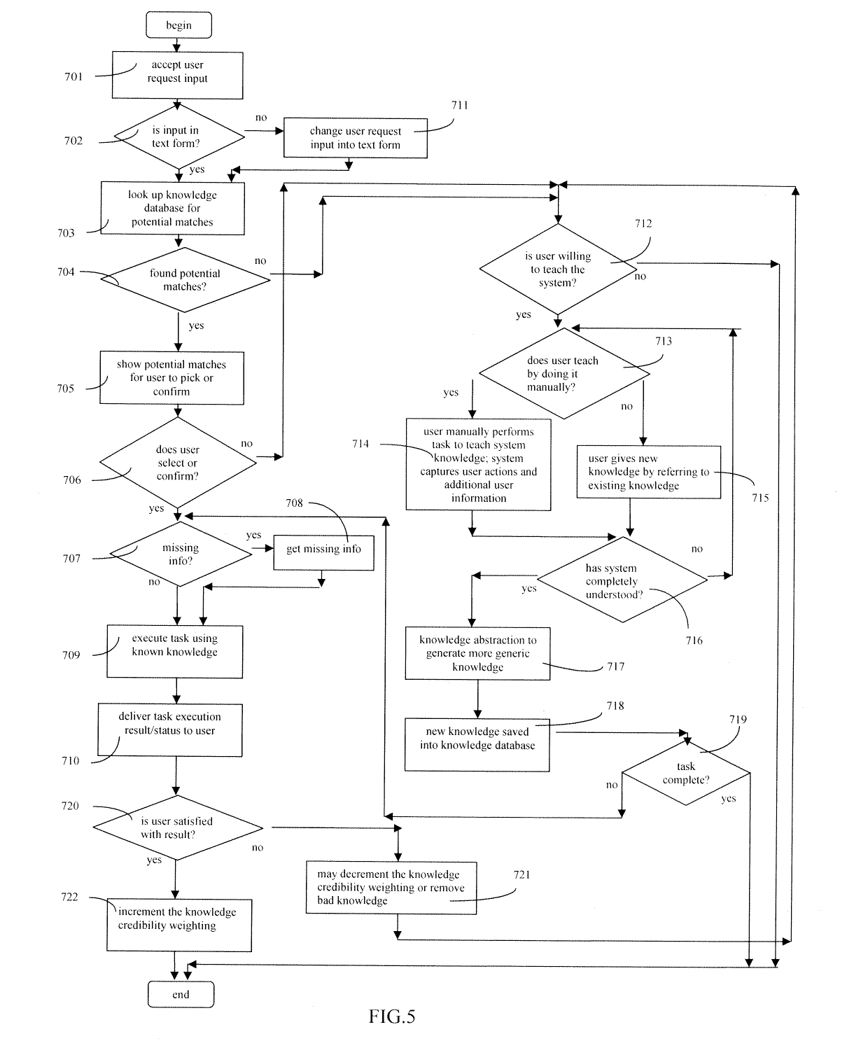

FIG. 5 depicts another example of a flowchart of the high level process of serving a human request by a designed intelligent assistant system 100.

In the example of FIG. 5, the assistant system 100 (through user interaction engine 102) accepts a user's request input at step 701. If the request input is determined to be in text form at step 702, flow goes to step 703; otherwise, user interaction engine 102 (probably through intelligent user interface module 1001)transforms the input into text form at step 711 before going to step 703. At step 703, resolver module 1008 of execution engine 106 looks up its knowledge database 1010 for potential matches with known requests or request patterns; then if it is determined there is any potential match at step 704, flow goes to step 705; otherwise, flow goes to step 712. If there is one potential match, user interaction engine 102 may show the potential match to the user for confirmation at step 705. If there are more than one potential matches, user interaction engine 102 may show the potential matches for the user to select. If the user does not confirm or does not select any of the potential matches at step 706, which means that there is no match for user's request, so flow goes to step 712. At step 712, user interaction engine 102 tells the user that the assistant does not know how to handle the request, and asks the user to teach the system how to perform the task. If the user is willing to teach the assistant, flow goes to step 713, otherwise, the process is ended.

Continuing in the example of FIG. 5, if the user chooses to teach the assistant by doing it manually using the provided user interface at step 713, flow goes to step otherwise, flow goes to step 715. At step 714, the user manually performs the corresponding task, and during the process, and may give additional information such as how to collect the result/status and how to verify the result/status; in the meantime, observer module 1003 of learning engine 104 captures all the user actions, and records them with all the information that the user may give. After step 714, flow goes to step 716. At step 715, the user gives new knowledge through reader module 1005 of learning engine 104 by referring to existing knowledge, then flow goes to step 716. Then at step 716, if learner module 1004 of learning engine 104 determines that the user request can be well understood by using the new knowledge given at step 715 or step 714, flow goes to step 717; otherwise, flow returns to step 713 to repeat the learning process again. At step 717, abstractor module 1006 of learning engine 104 does the knowledge abstraction to generate more generic knowledge using both the newly obtained knowledge and old knowledge; then at step 718, learner module 1004 saves the new knowledge into its knowledge database; finally, flow goes to step 719 where, if the task is already completed during the learning process at step 714, the flow is ended; otherwise, flow goes to step 707. At step 707, if information is complete for executing the user requested task, flow goes to step 709; if there is any missing information that is required for performing the user requested task, flow goes to 708 to get the missing information from the user, then, flow goes to step 709, where task is performed by execution engine 106 (probably through imitator module 1007) to serve the user's request. Then at step 710, task execution result and/or status is delivered to the user. Note that step 709 and step 710 may happen repeatedly. At step 720, if the user is satisfied with the result, flow goes to step 722 where learner module 1004 of learning engine 104 increments the corresponding knowledge credibility weighting, so that positive feedback reinforces the effective knowledge, then finally flow is ended. If at step 720, the user is not satisfied with the result/status, flow goes to step 721 where, learner module 1004 may decrement the corresponding knowledge credibility weighting for the user, so that negative feedback may weaken the ineffective knowledge and may even cause bad/outdated knowledge to be removed from the knowledge database. Note that at 721, the user may add additional knowledge to improve the existing knowledge; in that case, existing knowledge credibility may not change. The flow returns to step 712 after step 721.

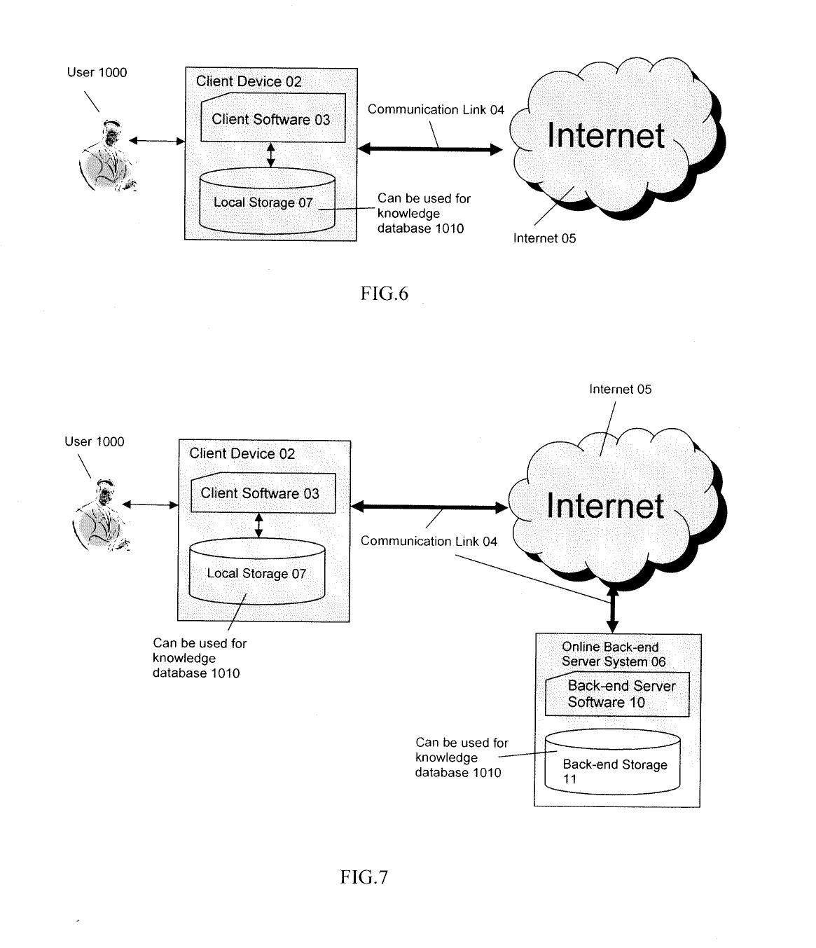

FIG. 6 illustrates a non-limiting example in which the assistant system 100 being designed using the disclosed invention is a piece of standalone client software 03 running within a client device 02, and a user 1000 directly interacts with the client device 02. The client device 02 has access to the Internet 05 using some communication link 04. In one embodiment of the invention, the client software 03 may be a specially designed web browser, or some software incorporating web browser functionalities, using the disclosed invention. Relating to FIG. 1, FIG. 3 or FIG. 4, this kind of configuration may have all or most of engines and components implemented in one software package and deployed in one place. In some embodiments, system 100 makes use of local storage 07 for knowledge database 1010.

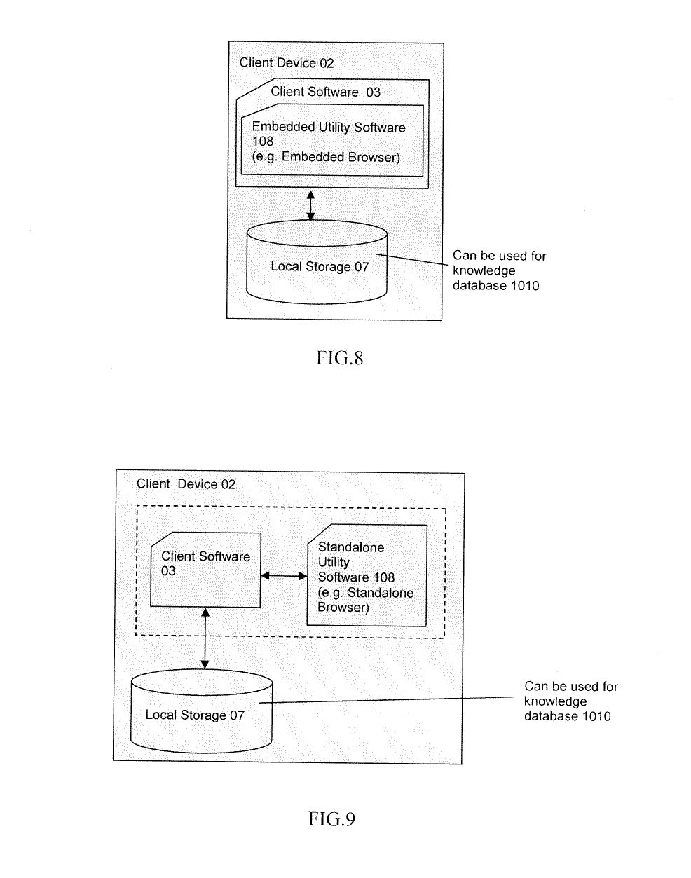

FIG. 7 illustrates another non-limiting example in which the assistant system 100 being designed using the disclosed invention is an online service system that comprises both client software 03 running within a client device 02, and an online back-end server system 06, and both are connected to the Internet 05 through some communication link 04. As in FIG. 6, in one embodiment of the invention, client software 03 may be a specially designed web browser, or some software incorporating web browser functionalities. In FIG. 7, the aforementioned engines of system 100 can be at client device 02 and/or at the back-end server system 06, e.g., at least part of the learning engine and execution engine may reside in back-end server system instead of being all within the client device. In some embodiments, system 100 makes use of local storage 07 for local knowledge database 1010, and/or makes use of back-end storage 11 for back-end server knowledge database 1010. Though not required, local database at local storage 07 may still be very useful for knowledge database due to the following reasons: first, some users may be more comfortable with their private knowledge being stored in their own device rather than in a public online service system, even if the public online service system can also be designed to protect privacy and security; second, for performance reasons, the client software may perform the actual tasks for users, so it may be preferable that at least part of the knowledge being used can be saved in client device for use.

To further explain how embedded application works in FIG. 3, FIG. 8 illustrates a non-limiting example in which client software 03 of system 100 has a piece of embedded utility software 108 as part of its own. In this case, the client software 03 is called the “host” application or “host” software. It may be preferable that the “host” software is a software platform with all the aforementioned aspects of the invention being implemented, so that all (utility) applications running within the “host” platform can be assisted by the designed system. If the “host” software 03 is an operating system platform, the embedded utility software 108 can be any application software that is developed and run on top of operating system 03. If the “host” software is not an operating system, the system in FIG. 8 may be implemented using libraries provided by the utility software vendor. For example, Microsoft Windows application can have an embedded browser. For another example, Google Android mobile platform allows its mobile application to have an embedded browser as well. For embedded applications, there may be APIs available for communications between the host client software 03 and the embedded software 108.

To further explain how external application works in FIG. 4, FIG. 9 illustrates another non-limiting example in which a designed client software 03 of system 100 runs in parallel with some external/standalone utility software 108 within the client device 02, and the client software 03 communicates with the standalone utility software 108. The user's actions are normally received by the standalone utility software 108, and it may be possible for the utility software 108 to report the captured user actions back to the client software 03, using APIs provided by the utility software vendor. For example, some browser can be launched by other applications, and there are some APIs that allow other applications to communicate with the browser, so that user action capturing and imitating can be realized. From a user's perspective, the client software 03 and the utility software 108 are two applications running in the client device 02 at the same time, with the former controlling the latter. However, for convenience of discussion, 03 and 108 are sometimes referred to as one entity using the term “client software” in general, unless interaction between the two is explicitly discussed, or the utility software specific functionality needs to be discussed separately.

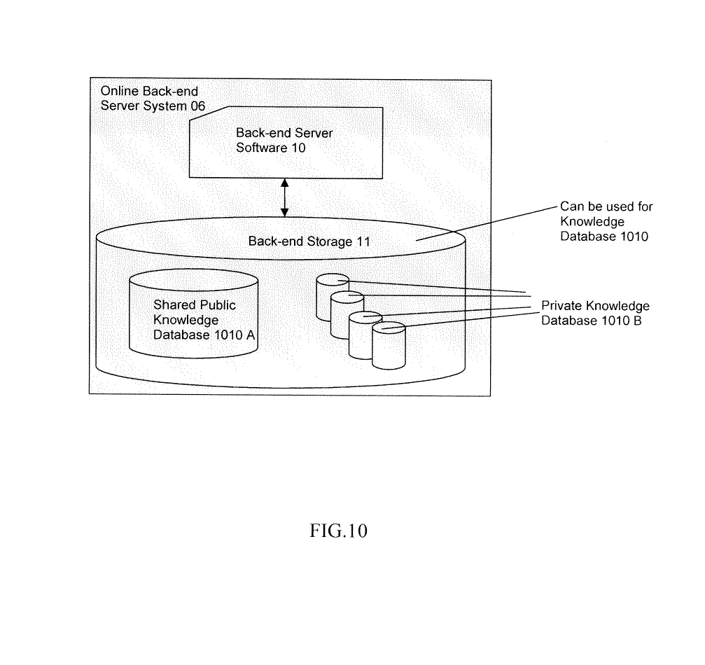

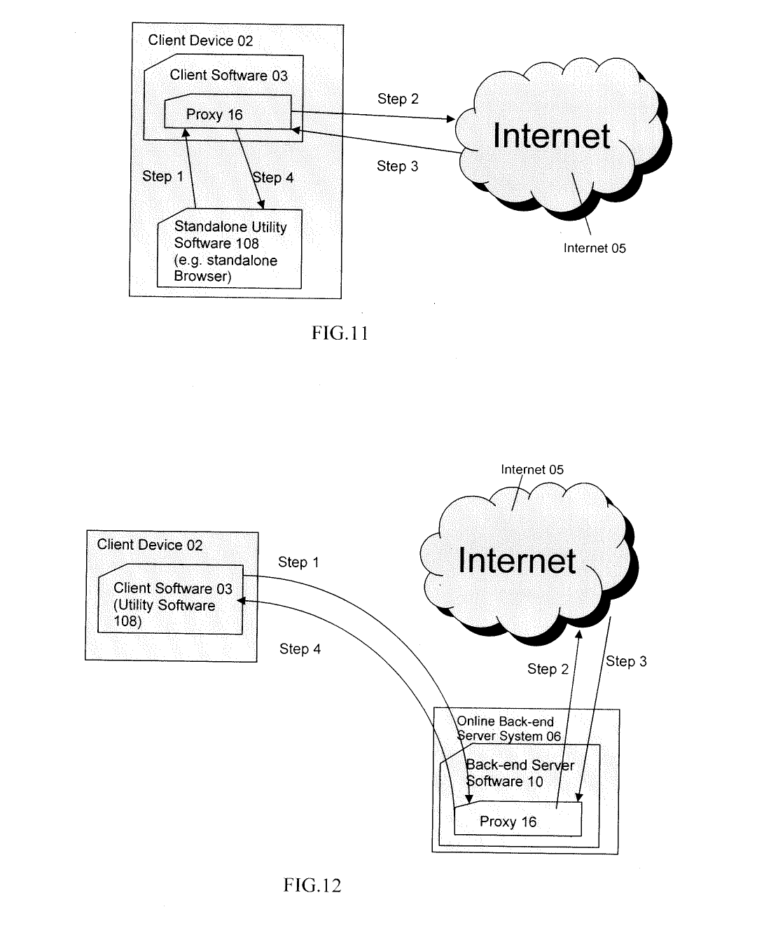

FIG. 10 illustrates a non-limiting example in which an online back-end server system 06 of system 100 designed using the disclosed methods uses storage sub-systems 11 to save and maintain different types of knowledge database 1010. The knowledge database includes shared public knowledge database 1010 A and private knowledge database 1010 B. Different types of knowledge can be properly segregated, so that private knowledge can only be accessible for its intended users.

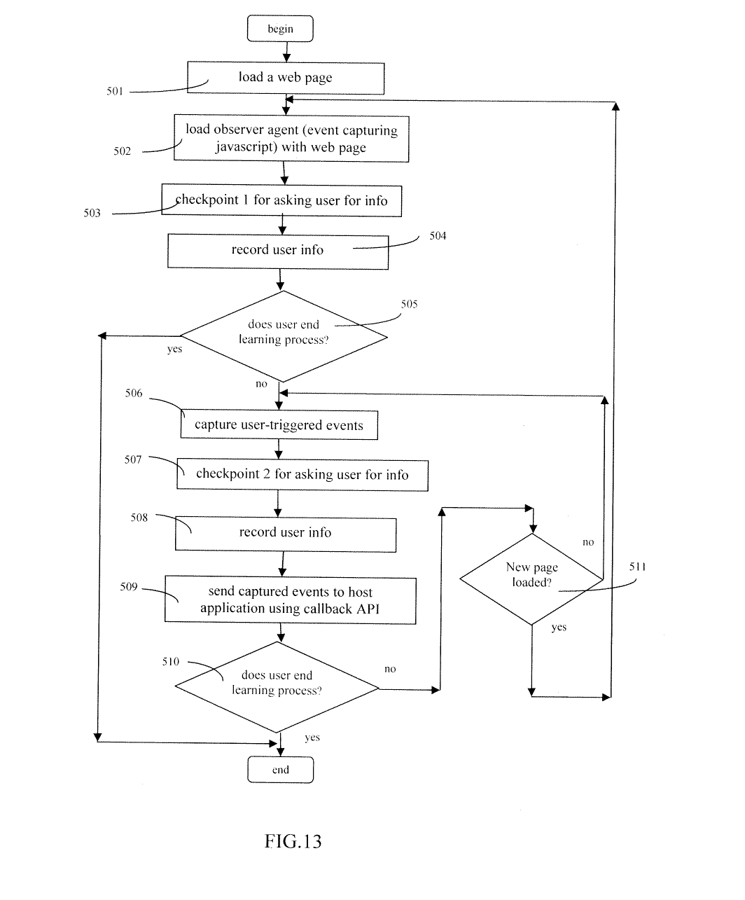

FIG. 11 explains one possible example of how proxy mechanism works. In FIG. 11, a proxy 16 is implemented within client software 03 of system 100, so that when the client software 03 launches and drives external/standalone utility software 108, e.g. a standalone browser, its proxy 16 is set to be used by the utility software 108, so that the utility software 108 interacts with the proxy 16 to access the Internet 05. When the utility software 108 needs to send a request to some Internet place, in step 1, the request is first sent to the proxy 16, then in step 2, the proxy 16 forwards the request to the destination in the Internet 05; then in step 3, the proxy 16 receives the response back from the Internet 05, and forwards the response back to the utility software 108 in step 4. Because the proxy 16 stands in the middle between the utility software 108 and the Internet 05, it is able to see and even modify the traffic between the two, so it has the opportunity to observe user's actions behind the scene, and even to imitate user's actions. (Note that it may not be necessary to implement imitator functionality using proxy mechanism if there is a back-end system to do the task)

FIG. 12 further explains yet another possible example of how proxy mechanism works. In FIG. 12, a proxy 16 is implemented within back-end server software 10 within an online back-end server system 06 of system 100. When the client software 03, which may contain or be utility software itself, needs to send a request to some Internet place, in step 1, the request is first sent to the proxy 16, then in step 2, the proxy 16 forwards the request to the destination in the Internet 05; then in step 3, the proxy 16 receives the response back from the Internet 05, and forwards the response back to the utility software 108 in step 4. Again, the proxy 16 has the opportunity to capture user's actions since it is able to see and even modify the traffic between the client software 03 and the Internet 05. This kind of configuration may be useful if the client software 03 used by a user is some utility software that is not provided by the designed system 100, and cannot be extended or modified in any way.

In some embodiments, proxy may be used to load observer/imitator module into client utility software. In the example of both FIG. 11 and FIG. 12, sometimes it may be difficult to repeat/imitate what a user does simply by looking at the interaction traffic. If the utility software 108 has rich functionalities, such as a browser running a dynamic web application, it is possible that a task is done through multiple requests/responses in which there may be some hidden parameters inaccessible by the proxy, and later request/response pair may depend upon earlier request/response pair, which may be impossible to repeat. Sometimes, this may be resolved by proxy loading event capturing/recording code into the utility software 108 by modifying the response back from the Internet. For example, a user may choose to use any kind of browser to access the Internet, and is not able to or does not want to download any plugin/extension or any other new software from the back-end system; in that case, system 100 can use the proxy 16 to modify the response page from the Internet, to load some Javascript code into the response page, or even to dynamically rewrite some of the page logic in order to implement the observer and imitator related module. The purpose of the description here is to demonstrate the possibility of implementing the required observer and imitator functionalities when using a proxy configuration is required/viable.

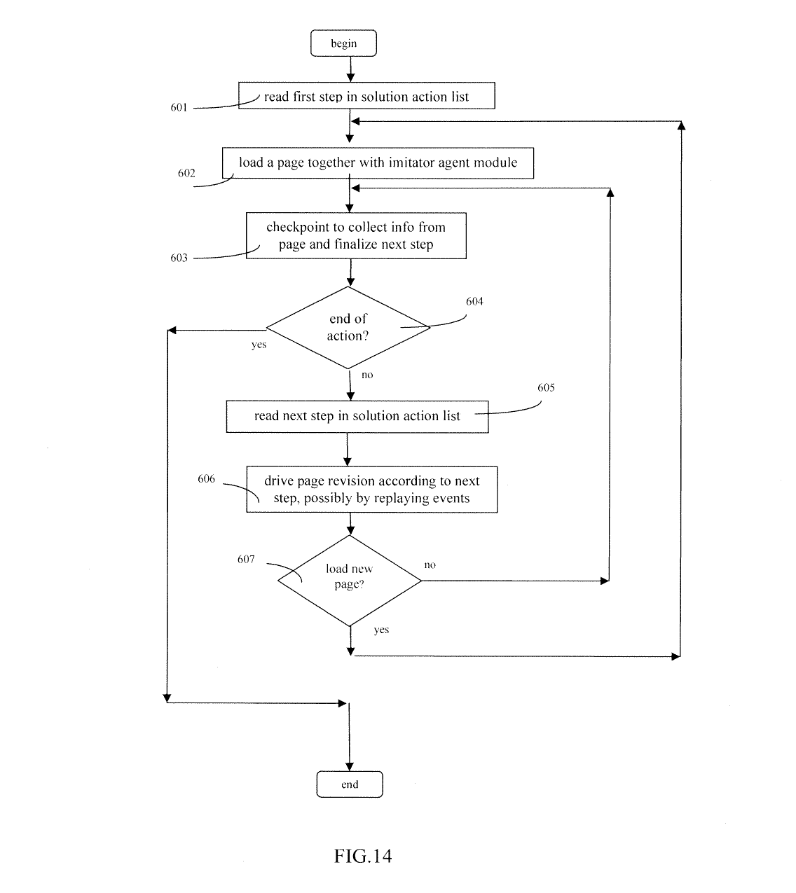

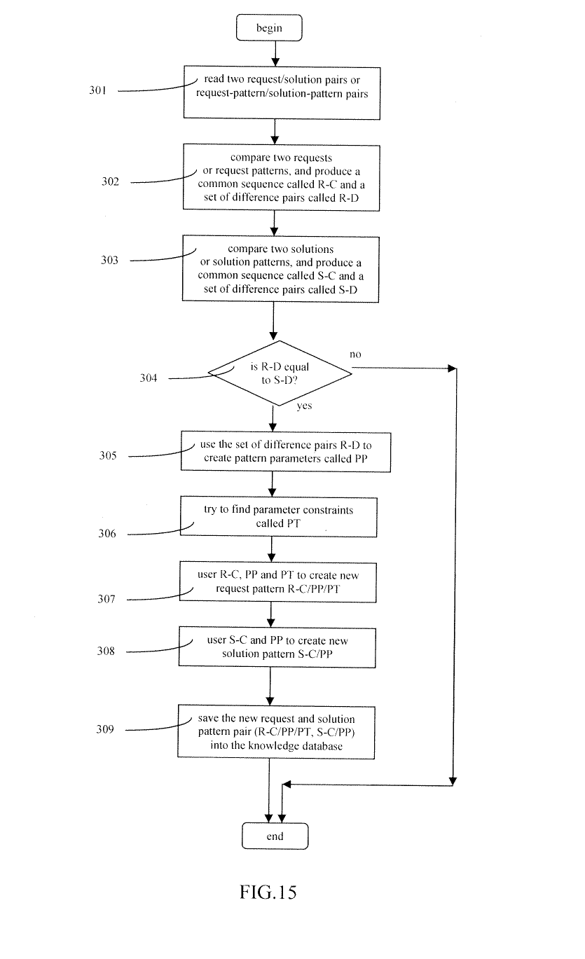

To further explain how observer and imitator related functionalities are implemented, the sections below use two figures for an embodiment of the invention—FIG. 13 is for observer functionality and FIG. 14 is for imitator functionality. In this embodiment, the client software of system 100 is a Google Android application software running in a mobile device. The assistant user interface has some input textbox that allows a user to type in requests in simple text or human language, just as a phone providing an interface for user to do texting. The assistant user interface also uses Google Voice support to provide a voice input interface, using Google Voice service to translate voice to text requests. Context of user input such as location and time of the input are also collected as part of the user request when the information is available.

In the embodiment mentioned above, the associated utility software is web browser. The client software of system 100 implements an embedded web browser in order to support all web applications. The Android application is developed using Java development kit provided by Google, and the embedded web browser is implemented in the Android host application using WebView and related classes provided in the Google APIs and libraries. The Android host application can launch the embedded web browser at any time, and drive it to any web pages, using API functions such as loadUrl( ). Note that web browser standards support browser event capturing and replaying. This can be normally achieved by loading script code within browser extension or within loaded web pages. To implement the user action capturing/recording functionality, the host application makes use of the browser view event callback handler APIs. Events can be reported back to the host application by the callback APIs. In particular, when a page is downloaded in the said embedded web browser, the event callback handler such as on PageFinished( ) is called, then, event capturing Javascript library code as the observer agent module can be injected into the downloaded page using the WebView class API functions such as loadUrl( ) so that user actions can be observed and recorded. Also, there is a callback mechanism provided in the APIs (e.g. addJavascriptInterface( ) API function) that allows Javascript on the web page to call back the Android host application, so that the captured user actions can be reported back to the Android host application. To implement the user action imitating event driving Javascript library code as the imitator agent module can also be dynamically loaded using similar mechanism as described above.

FIG. 13 illustrates the flowchart of the aforementioned learning by observing process for the embodiment mentioned above. The learning process starts by loading the first web page for user at step 501. Then, at step 502, observer agent module (event capturing Javascript code) of learning engine 104 is dynamically loaded into/with the loaded web page by using the browser provided API. At step 503, the learning engine 104 reaches the first “checkpoint” or the first opportunity to ask the user for more information about the user's action. For example, if the user is searching for something, the learning engine 104 can ask whether the searched information is on the loaded page; and if the answer is yes, which part of the page contains the interested information, etc. At step 504, the user-provided information is recorded. Note that step 503 and 504 are optional. At step 505, if the user finishes teaching the assistant, the whole process is ended; otherwise, the process goes to step 506. At step 506, user drives the embedded browser by clicking or typing etc., and user-triggered events are captured by the assistant. At step 507, the learning engine 104 reaches another “checkpoint” or opportunity to ask the user for more information about the user's action, such as how the user picks from options if the user action is about selecting option on the web page. At step 508, the user action is recorded. Again, step 507 and 508 are optional. At step 509, captured events are sent back to the Android host application, using the callback API as mentioned before. At step 510, if the user finishes teaching the system, the whole process is ended; otherwise, the process goes to step 511. At step 511, if a new page is loaded, the process goes to 502; otherwise, the process goes to step 506.

FIG. 14 illustrates the flowchart of the user action repeating/imitating process for the embodiment mentioned above. In the embodiment, the solution of serving a user's request comprises an action list with every step of actions that the assistant can perform. The process starts by reading the first step in solution action list at step 601. Then, at step 602, the execution engine 106 of system 100 loads the starting page together with the imitator agent module. At step 603, the execution engine 106 reaches the checkpoint or opportunity at which it can collect useful information from the loaded page. The information collected at step 603 may be the information the user is looking for; or, it may be useful for guiding the next step of action, if the next step of action may depend on the result of the previous step—in that case, the information is used to finalize the next step. At step 604, if the end of the action list is reached, i.e., all steps have been performed, the whole process is ended; otherwise, the process goes to step 605. At step 605, the execution engine 106 reads the next step in the solution action list. Then, at step 606, the execution engine 106 drives the web page according to the instructions in the step description, using the API mentioned before, possibly by replaying some recorded events. At step 607, if a new page needs to be loaded, the process goes to step 602; otherwise, the process goes to step 603.

FIG. 15 depicts a flow diagram of the knowledge abstraction process in some embodiments. At the beginning of the process, the learning engine 104 of assistant system 100 reads two request/solution pairs or request-pattern/solution-pattern pairs at step 301. Then at step 302, the two requests or request-patterns are compared against each other to produce a common sequence part called R-C, and a set of difference pairs called R-D. For an example, for user request “what is the temperature of New York now?” and user request “what is the temperature of Boston now?”, the common sequence part R-C can be (“what is the temperature of”, “now?”), and the set of difference pairs can be {“New York”/“Boston”}. At step 303, the two solutions or solution-patterns are compared against each other to produce a common sequence part called S-C, and a set of difference pairs called S-D. The process is similar to the request example.

In FIG. 15, at 304, R-D and S-D obtained at step 302 and 303 respectively are compared to see whether they are the same. If R-D and S-D are not the same, the whole process is ended; otherwise, flow continues to step 305. At step 305, the set of difference pairs R-D is used to create pattern parameter set called PP. At step 306, effort may be tried to find and generate potential parameter constraints called PT. For the above example, the R-D is {“New York”/“Boston”}, and the learning engine 104 may notice (according to knowledge database 1010) that both “New York” and “Boston” are US cities, and maybe that is the constraints for the corresponding pattern parameters. At step 307, R-C, PP and PT generated at previous steps are used to create new request pattern R-C/PP/PT. At step 308, S-C and PP generated at previous steps are used to create new solution pattern S-C/PP. Finally, at step 309, the pair of the new request pattern and new solution pattern (R-C/PP/PT, S-C/PP) is saved into knowledge database 1010 as new generic knowledge, and the whole process is ended. For the above example, the pattern pairs could be ((“what is the temperature of”, “now?”)/{*}/{“US city”}, (“go to www.weatherxyz.com, enter ‘′’, ‘′’, submit request”)/{*}), and this can be translated into an equivalent form ((“what is the temperature of * now?”)/{“US city”}, (“go to www.weatherxyz.com, enter ‘*’, submit request”)). Note that the above mentioned process may be repeatedly run for all request/solution and request-pattern/solution-pattern pairs in the whole knowledge database 1010, and optimization may be done to make traversing the database efficient.

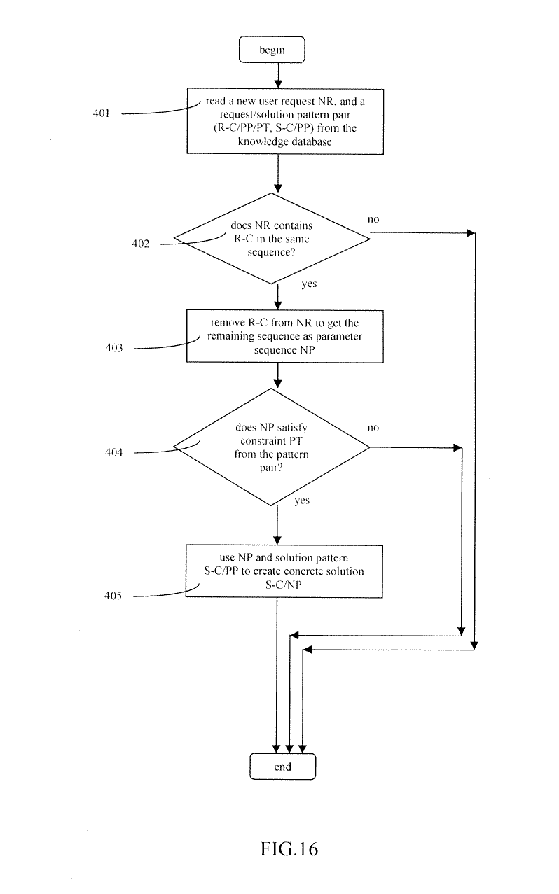

FIG. 16 depicts a flow diagram of the process of doing pattern match and solution pattern instantiation in some embodiments. Pattern match is used to find matched request pattern for a new user request, so that corresponding solution pattern can be obtained from the knowledge database. Solution pattern instantiation is used to generate concrete solution to a new user request based on some existing solution pattern. At the beginning of the process, at step 401, the execution engine 106 of system 100 reads a new user request, and then reads a request/solution pattern pair (R-C/PP/PT, S-C/PP) from the knowledge database 1010. At step 402, the execution engine checks whether the user request NR matches the request/solution pattern pair; it does this by checking whether NR contains the same sequence as specified by R-C. If NR does not contain R-C, the pattern match is considered failed, and the process ended; otherwise, flow continues to step 403. At step 403, a sequence is generated by removing R-C from NR, and the sequence is the potential parameter sequence called NP. Then at step 404, NP may be tested against the parameter constraint PT from the request/solution pattern pair. If at step 404, NP does not satisfy the constraint PT, the process is ended; otherwise, the request pattern is considered to be a match for the user request, and flow goes to step 405. At step 405, NP and solution pattern S-C/PP are used to create the concrete solution S-C/NP, and the process is ended. For the above example, if new request NR is “what is the temperature of Chicago now?”, using the generated pattern pair before, this NR contains the R-C sequence, and the generated NP is “Chicago”, which satisfies the constraint PT {“US city”}, so it is a match; thus, NP and S-C/PP are used at step 405 to generate the concrete solution “go to www.weatherxyz.com, enter ‘Chicago’, submit request”. Note that for a new user request, all request/solution patterns in the knowledge database may be tested using the above mentioned procedure, and optimization may be done to make traversing the database efficient.

Note that FIG. 15 and FIG. 16 just show one of the simplest methods for doing knowledge abstraction, and show how the generic knowledge generated by knowledge abstraction can be applied to a user request, even if it is a request that the system 100 has never seen and has never directly learned from users before. Much more complicated methods and algorithms can be developed for the designed assistant, especially those with semantic analysis, which may or may not be directly based on the above mentioned method, but should still be regarded to be within the scope and spirit of the invention disclosed herein.

The following provides more details about the workflows with respect to some example configurations, deployment arrangements of the designed intelligent assistant system 100.

FIG. 17 illustrates the system interactions and workflow steps of an embodiment of the invention in which the designed system 100 is a piece of standalone client software. It highlights the aspects of how the system 100 obtains some knowledge from a user for performing a task.

In FIG. 17, in step 1, a user 1000 sends a request to the interaction engine 102 within client software 03 in client device 02 of system 100. Depending on the client device input mechanism, the user 1000 may type text request using a keyboard or keypad; or the user may just speak to the client device, and device may translate the voice input into text form.

In FIG. 17, in step 2, the execution engine 106 within client software 03 tries to see whether it knows how to serve the user's request by consulting with the knowledge database 1010. If the knowledge to serve the user's request is not found or the information is incomplete for serving the user's request, in step 3, the client software 03 notifies the user 1000 in the user interface. It is also possible that the client software finds some candidate(s) in the knowledge database 1010 that may match user's request, and may ask the user 1000 to select one of the candidate(s) in step 3 to start the task, but the user 1000 may choose not to select any of the given options. Either way, the user 1000 may choose to go with step 4 asking system 100 to learn from the user how to perform the task, and the knowledge is offered by the user 1000 in step 4.

In FIG. 17, in step 4, learning engine 104 may enable the user 1000 to show how the intended task can be performed manually by the user. In an embodiment that the client software supports web browsing, depending on how the functionality is implemented, the user may interact with a new browser window in addition to the existing client software window, with one window acting as a control/dialog window, and the other window being used by the user to manually perform the task to show the system. In another implementation, the user 1000 may see a browser sub-frame/view within the client software window, and the user is able to use the browser frame/view to manually perform the task to show the system, while the user can still conduct dialog with the system using controls outside the browser sub-frame/view, providing additional information about the user's actions. In yet another implementation, the user 1000 may use a single browser window, while conducting control and dialog with the system using voice input. No matter in which way it is implemented, the learning engine 104 within the client software 03 enables the user 1000 to start the learning process, and it may enable the user 1000 to provide additional information during the learning process, and it enables the user 1000 to end the learning process. For example, when the user 1000 is searching for bargain price using a web browser view or window, the user 1000 may be able to navigate to a web page that contains an interested price item, highlight or click the interested price portion on that web page, and through the control window or other methods, the user 1000 may inform the learning engine 104 that the highlighted or clicked portion is what the user is interested in.

In FIG. 17, in step 4, it is also possible that the user 1000 chooses to show how the intended task can be performed by referring to some knowledge that the system already knows. In case the system does not fully understand the current request, system 100 may show some similar requests that it knows how to handle, and let the user 1000 pick one of them. For more complicated cases, learning engine 104 may enable the user 1000 to combine several requests into one task, with all of them being clearly understood by the system. If execution engine 106 knows how to serve the user's request, but needs more information to proceed, the client software may also obtain that information in step 4. For example, if the user 1000 wants the system to use the user's email account to send an email, and the user doesn't want email account password to be remembered by the system, the user may offer that information in step 4 to allow the system to perform the task.

In FIG. 17, the knowledge obtained in step 4 is subsequently saved into knowledge database 1010 in step 5, and execution engine 106 of system 100 subsequently uses that knowledge to perform the task on the Internet 05 in step 6. Note that for private knowledge, it may or may not be saved persistently if it is only used for one time, depending on the task and privacy requirements. For example, if the task is not performed immediately, but run at a later time, the private knowledge has to be kept somehow to allow asynchronous execution, but the private knowledge does not need to be kept once the task is over, if the user does not want it to be remembered.

Note that knowledge abstraction process can be run at step 5 to obtain more generic knowledge by learning engine 104, while it can be run at some other times as well. Since there is new knowledge to be consumed by the system in step 5, the learning engine 104 can compare it with what it already knows, to find new potential commonalities and correlations within knowledge database 1010, and possibly to generate new generic knowledge.

In FIG. 17, the result/status of performing the task is eventually delivered by execution engine 106 to the user 1000 in step 7, and user confirmation and feedback happens at step 8. Note that step 6 and step 7 can also happen in parallel, meaning user 1000 can be updated during the task is executed.

Note that in FIG. 17, in step 4, if the user 1000 chooses to show the system how to perform the task by completing the task manually, step 6 and step 7 can actually happen during the learning process in step 4, and step 5 can happen last after the learning process. In another case, the user may have shown the system how to perform the task in step 4; even if step 6 may happen during the process, the user's request may contain some asynchronous processing requirement, so that step 6 and step 7 may happen long after step 4. For example, the user 1000 may ask the system to monitor some stock price online, and in case the monitored price drops or rises to certain level, the user may like to be informed; in this case, step 6 and step 7 may happen more than once from time to time, until the user 1000 drops the task. In another example, the client device 02 is a smart phone, and the user 1000 would like it to report headline financial news next morning; in this case, step 6 and step 7 would happen next morning, as specified by the user.

FIG. 18 illustrates the same system configuration in FIG. 17, while it highlights the aspects of how the designed system 100 uses existing knowledge to perform a task for a user, and how system 100 allows revision and improvement of existing knowledge through feedback and more learning process.

In FIG. 18, the user 1000 sends a request through interaction engine 102 to the client software 03 in step 1, and the execution engine 106 looks up knowledge database 1010 in step 2 and finds some existing solution(s) to serve the user's request. So in step 3, the execution engine 106 interacts with Internet 05 to perform the task, and delivers the result/status to the user 1000 in step 4.

In FIG. 18, the user 1000 may not be completely satisfied with the result given in step 4. It may be because the result is completely wrong, or the user 1000 thinks that better result(s) can be obtained. Either way, the user 1000 chooses to give the system new knowledge about performing the requested task in step 5 through learning engine 104. In step 6, the new knowledge is saved into the knowledge database 1010. Note that the new knowledge may be some improvement to the existing knowledge, meaning that the old knowledge used by the system in step 2 and step 3 may still be valid and useful for the user. For example, the user 1000 may request some flight information, and the system gets the information from some website A, but the user 1000 may tell the system that sometimes some better information can be obtained from some other website B. Even for the case that the user thinks the result/status is undesirable, the old knowledge may not be invalid and may not be removed from the knowledge database immediately, because there may be various reasons why the user 1000 sees and invalidates some result in step 4, and the old knowledge may still be useful in the future. The learning engine 104 may adjust the credibility weightings of the existing knowledge, which may affect the selection of knowledge in the future. The learning engine 104 may revise and improve its knowledge in step 6, according to the feedback given by the user in step 5.

In FIG. 18, in step 7, the execution engine 106 uses the newly obtained knowledge to perform the task again, and result/status is delivered back to the user 1000 in step 8, and user confirmation and feedback happens at step 9.

FIG. 19 illustrates the system interactions and workflow steps of an embodiment of the invention in which the designed system 100 has both client software and an online back-end server system. It highlights the aspects of how the system 100 obtains some knowledge from a user for performing a task in this configuration.

In FIG. 19, a user 1000 sends a request through user interaction engine 102 to client software 03 in client device 02 in step 1. In step 2, execution engine 106 within the client software 03 tries to see whether it knows how to serve the user's request by consulting with the local knowledge database 1010 in client device 02. If the knowledge to serve the user's request is not found, the client software 03 would contact the online back-end server system 06 in step 3, with the user's request; then, in step 4, execution engine 106 within the back-end server software 10 would try to look up knowledge database 1010 at the back-end server for useful knowledge to serve the user's request. If still no match is found in step 4, the back-end system 06 would notify the client software 03 in step 5, and the client software 03 would notify the user 1000 in step 6. If the user's request is a private request associated with private knowledge, and if the user only wants private knowledge to be stored in local knowledge database in client device 02, then none of step 3, step 4 and step 5 would happen; instead, after no match is found in step 2, the client software would notify the user 1000 in step 6. As described before, if execution engine 106 needs more information to perform the task, the client software 03 may also ask the user 1000 for the information in step 6.

In FIG. 19, similar to previous cases, after being notified in step 6, the user 1000 may provide the knowledge to perform the task in step 7, and the learning engine 104 within client software may start the learning process. The knowledge provided in step 7 is stored in the local knowledge database 1010 in step 8; the knowledge is also transferred to the online back-end system 06 in step 9 if the knowledge is sharable public knowledge, and the knowledge is also saved into the knowledge database 1010 at the back-end system in step 10. At the time the knowledge is saved to either knowledge database, knowledge abstraction may happen to get more generic and refined knowledge by learning engine 104. Since the back-end system is usually a much more powerful system than the client device, it is conceivable that the knowledge abstraction process by learning engine 104 at the back-end system may be more complicated and may produce more useful result.

In FIG. 19, once the needed knowledge is obtained in step 7, execution engine 106 within the client software 03 may perform the task in step 11, using the learned knowledge, and the result/status is eventually delivered to the user 1000 in step 12. If performing the task is desirable at the back-end system, execution engine 106 of the back-end system would start the task in step 13; then, the back-end system would deliver the result/status of performing the task to the client software 03 in step 14, and the latter would eventually deliver the result/status to the user 1000 in step 15. Finally, user confirmation and feedback happens at step 16.

FIG. 20 has the same system configuration as FIG. 19, while it highlights the aspects of how the designed system 100 uses the existing knowledge to perform a task for a user, and how the system 100 allows revision and improvement of existing knowledge through more learning process.

In FIG. 20, a user 1000 sends a request through user interaction engine 102 to client software 03 in client device 02 in step 1. In step 2, execution engine 106 within the client software 03 tries to see whether it knows how to serve the user's request by consulting with the local knowledge database in client device 02. If no match is found in step 2, as in the case in FIG. 19, the client software 03 may forward the user's request to the back-end system 06 in step 3; and if there is a match in step 4 in the knowledge database 1010 of the back-end system 06, the knowledge would be transferred back to the client software 03 in step 5, and the knowledge will be saved into the local knowledge database 1010 in client device 02 in step 6. On the other hand, if a match is already found in step 2, there is no need to contact the back-end system, so none of step 3, step 4, step 5 and step 6 would happen. No matter where execution engine 106 within the client software 03 gets the required knowledge, the client software 03 can perform the task in step 7 using the required knowledge, and the result/status would be delivered to the user 1000 in step 8.

In FIG. 20, if the user 1000 is not completely satisfied with the result/status, in step 9, the user 1000 provides new knowledge to the system through learning engine 104. The new knowledge is saved into the local knowledge database 1010 in step 10, and may be transferred to the back-end system 06 in step 11, and subsequently saved into the knowledge database 1010 at the back-end system 06 in step 12. As described before, knowledge abstraction process may happen in step 10 and step 12. The execution engine 106 within client software 03 may perform the task in step 13 again, using the newly obtained knowledge, and the result/status may be delivered to the user 1000 in step 14. As described before, if performing the task is desirable at the back-end system 06, the execution engine 106 at the back-end system 06 would start the task in step 15, and the result/status would be transferred back to client software 03 in step 16, and eventually delivered to the user 1000 in step 17. Finally, user confirmation and feedback happens at step 18.

There can be some variations of the examples illustrated in FIG. 19 and depending on whether the client software uses local knowledge database within the client device, and whether back-end system performs tasks for users. The workflows will be a bit different in those variations.

FIG. 21 depicts a screen shot of some embodiments when the intelligent assistant system 100 doesn't find existing knowledge to serve a user request “check the account balance of my TD bank checking account”, and it enables the user to either show or describe how to serve such user request (i.e. either using the “learning by observing” method, or using the “learning by reading method).

FIG. 22 depicts a screen shot of some embodiments when the intelligent assistant system 100 is in the process of “learning by observing”, in which the system 100 enables the user to use a browser to access the TD bank web site to check the account balance, and behind the scene, the learning engine 104 of assistant system 100 observes the user' actions and learns.

FIG. 23 depicts a screen shot of some embodiments when the intelligent assistant system 100 is in the process of “learning by reading”, in which the system 100 enables the user to describe how to serve the user's request using existing knowledge, and learning engine 104 of assistant system 100 learns from the user's description.

The foregoing description of various embodiments of the claimed subject matter has been provided for the purpose of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and various modifications that are suited to the particular use contemplated.

1. A system, comprising:
a user interaction engine, which in operation,
accepts a request from a user to perform an operation via a computing device, or a request to teach how to perform such an operation;
provides execution result of the operation back to the user;
an execution engine, which in operation,
looks up instructions, answer and/or solution from a knowledge database on how to serve the request by the user;
performs the operation requested by the user via the computing device using the knowledge in the database;
a learning engine, which in operation,
learns, verifies, and saves into the knowledge database new knowledge on how to perform the operation requested by the user via the computing device in real time if no existing knowledge in the database is found on how to serve the user's request, or if the user wants to teach new knowledge on how to serve the user's request.

2. The system of claim 1, wherein:
the user interaction engine enables the user to provide the request in human language or gesture.

3. The system of claim 2, wherein:
the user interaction engine accepts the request from the user in simple text form, wherein the request contains a simple description of the operation to be performed via the computing device.

4. The system of claim 2, wherein:
the user interaction engine accepts the request from the user in non-text gesture or encoded form that can be compared with each other or translated into a simple text form.

5. The system of claim 1, wherein:
the learning engine supports learning by observing, wherein the learning engine enables the user to show how to serve/execute the request by actually performing the operation step by step, and acquires knowledge by observing and recording information related to the steps performed by the user.

6. The system of claim 5, wherein:
the user interaction engine enables the user to perform the operation step by step and to provide additional information about the user's actions via a web browser.

7. The system of claim 5, wherein:
the learning engine enables the user to stop before finishing the operation if enough knowledge has been collected to perform the operation.

8. The system of claim 5, wherein:
the learning engine observes and records the operation by the user only with the permission of the user.

9. The system of claim 6, wherein:
the learning engine learns by observing the user how to search for information related to performing the operation requested on the Internet by enabling the user to search where the information is located on the Web.

10. The system of claim 5, wherein:
the learning engine, by digesting the information observed from the user, generates, verifies, refines, and/or saves new knowledge on how to serve the request of the user in the knowledge database in proper format in order to use the new knowledge to serve future user request.

11. The system of claim 1, wherein:
the learning engine supports learning by reading, wherein the learning engine enables the user to describe in text how to interpret and serve the user's request using existing knowledge in the knowledge database.

12. The system of claim 11, wherein:
the learning engine enables the user to describe how to interpret and serve the user's request using simple text and/or non-text gesture or voice.

13. The system of claim 11, wherein:
the learning engine enables the user to describe how to interpret and serve the user's request as a plurality of sub-tasks/steps, and further parses, interprets, organizes, verifies, and saves the plurality of sub-tasks/steps for future execution.

14. The system of claim 1, wherein:
the learning engine supports knowledge abstraction, wherein the learning engine generates new generic knowledge on how to perform the operation requested by the user from existing knowledge in the knowledge database.

15. The system of claim 14, wherein:
the learning engine generates a generic form of user request pattern and a generic form of solution pattern to serve the request by the user.

16. The system of claim 14, wherein:
the learning engine generates the generic knowledge on how to perform the operation requested by the user by figuring out intention of the user's actions via context and/or correlations among the request and the actions by the user.

17. The system of claim 1, wherein:
the learning engine supports learning from execution feedback, wherein the learning engine checks the execution result and/or feedback of the operation to improve or revise the corresponding knowledge in the knowledge database.

18. The system of claim 1, wherein:
the execution engine looks up the knowledge database for an answer to the user's request and/or to retrieve instructions to perform the operation in order to serve the user's request.

19. The system of claim 5, wherein:
the execution engine repeats and/or imitates what the user performed via the computing device according to user actions observed and recorded during the learning by observing process.

20. The system of claim 15, wherein:
the execution engine retrieves corresponding solution pattern for the request from the knowledge database to create a concrete solution for the request if there is a match between the user's request and a generic request pattern in the knowledge database.

21. The system of claim 1, wherein:
the execution engine enables the user to verify, dismiss, and/or provide feedback to the execution result provided.

22. The system of claim 1, further comprising:
said knowledge database maintaining a set of knowledge, wherein such knowledge comprises a mapping between potential user requests and answers/solutions to fulfill the requests, including instructions to perform corresponding operations to serve the user requests.

23. The system of claim 22, wherein:
the knowledge database maintains separately public knowledge, shared knowledge, and private knowledge from different users.

24. The system of claim 22, wherein:
the knowledge database is pre-populated with a set of common knowledge to be used to perform the operation requested by the user without learning first from the user.

25. A method, comprising:
accepting a request from a user to perform an operation via a computing device, or a request to teach how to perform such an operation;
looking up matched instructions, answer and/or solution from a knowledge database on how to serve the request by the user;
learning, verifying, and saving into the knowledge database new knowledge on how to perform the operation requested by the user via the computing device in real time if no existing knowledge is found in the knowledge database on how to serve the user's request, or if the user wants to teach new knowledge on how to serve the user's request;
performing the operation requested by the user via the computing device using the knowledge in the database, and providing execution result of the operation back to the user.

26. The method of claim 25, further comprising:
enabling the user to provide the request in human language or gesture.

27. The method of claim 26, further comprising:
accepting the request from the user in simple text form, wherein the request contains a simple description of the operation to be performed via the computing device.

28. The method of claim 26, further comprising:
accepting the request from the user in non-text gesture or encoded form that can be compared with each other or translated into a simple text form.

29. The method of claim 25, further comprising:
supporting learning by observing, which enables the user to show how to serve/execute the request by actually performing the operation step by step, and acquires knowledge by observing and recording information related to the steps performed by the user.

30. The method of claim 29, further comprising:
enabling the user to perform the operation step by step and to provide additional information about the user's actions via a web browser.

31. The method of claim 29, further comprising:
enabling the user to stop before finishing the operation if enough knowledge has been collected to perform the operation.

32. The method of claim 29, further comprising:
observing and recording the operation by the user only with the permission of the user.

33. The method of claim 30, further comprising:
learning by observing the user how to search for information related to performing the operation requested on the Internet by enabling the user to search where the information is located on the Web.

34. The method of claim 29, further comprising:
by digesting the information observed from the user, generating, verifying, refining, and/or saving new knowledge on how to serve the request of the user in the knowledge database in proper format in order to use the new knowledge to serve future user request.

35. The method of claim 29, further comprising:
repeating and/or imitating what the user performed via the computing device according to user actions observed and recorded during the learning by observing process.

36. The method of claim 25, further comprising:
supporting learning by reading, which enables the user to describe in text how to interpret and serve the user's request using existing knowledge in the knowledge database.

37. The method of claim 36, further comprising:
enabling the user to describe how to interpret and serve the user's request using simple text and/or non-text gesture or voice.

38. The method of claim 36, further comprising:
enabling the user to describe how to interpret and serve the user's request as a plurality of sub-tasks/steps, and further parsing, interpreting, organizing, verifying, and saving the plurality of sub-tasks/steps for future execution.

39. The method of claim 25, further comprising:
supporting knowledge abstraction, which generates new generic knowledge on how to perform the operation requested by the user from existing knowledge in the knowledge database.

40. The method of claim 39, further comprising:
generating a generic form of user request pattern and a generic form of solution pattern to serve the request by the user.

41. The method of claim 40, further comprising:
retrieving corresponding solution pattern for the request from the knowledge database to create a concrete solution for the request if there is a match between the user's request and a generic request pattern in the knowledge database.

42. The method of claim 39, further comprising:
generating the generic knowledge on how to perform the operation requested by the user by figuring out intention of the user's actions via context and/or correlations among the request and the actions by the user.

43. The method of claim 25, further comprising:
supporting learning from execution feedback, which checks the execution result and/or feedback of the operation to improve or revise the corresponding knowledge in the knowledge database.

44. The method of claim 25, further comprising:
looking up the knowledge database for an answer to the user's request and/or to retrieve instructions to perform the operation in order to serve the user's request.

45. The method of claim 25, further comprising:
enabling the user to verify, dismiss, and/or provide feedback to the execution result provided.

46. The method of claim 25, further comprising:
maintaining a set of knowledge, wherein such knowledge comprises a mapping between potential user requests and answers/solutions to fulfill the requests, including instructions to perform corresponding operations to serve the user requests.

47. The method of claim 46, further comprising:
maintaining separately public knowledge, shared knowledge, and private knowledge from different users.

48. The method of claim 46, further comprising:
pre-populating the knowledge database with a set of common knowledge to be used to perform the operation requested by the user without learning first from the user.
